(19) United States
(12) Patent Application Publication
(10) Pub. No.: US 2022/0242763 A1
(43) Pub. Date: Aug. 4, 2022

(54) Fail Safe Flushing BioReactor for Selenium Water Treatment

(71) Applicant: Frontier Water Systems, LLC, San Diego, CA (US)

(72) Inventors: James John Peterson, San Diego, CA (US); Timothy Michael Pickett, Salt Lake City, UT (US)

(73) Assignee: Frontier Water Systems, LLC, San Diego, CA (US)

(21) Appl. No.: 17/719,911

(22) Filed: Apr. 13, 2022

Related U.S. Application Data
(63) Continuation of application No. 16/840,383, filed on Apr. 4, 2020, now abandoned.
Application No. 16/840,383 is a continuation of application No. 15/632,708, filed on Jun. 26, 2017, now abandoned.
Application No. 15/632,708 is a continuation-in-part of application No. 14/210,325, filed on Mar. 13, 2014, now abandoned.
Application No. 14/210,325 is a continuation of application No. 13/803,904, filed on Mar. 14, 2013, now abandoned.
Application No. 15/632,708 is a continuation-in-part of application No. 14/210,310, filed on Mar. 13, 2014, now abandoned.
(60) Provisional application No. 61/842,381, filed on Jul. 3, 2013.
(60) Provisional application No. 61/842,382, filed on Jul. 3, 2013.

(51) Int. Cl. C02F 3/28; B01D 61/14; B01D 61/02; B01D 61/04; C02F 9/00; C02F 3/30; B01D 61/58; C02F 3/00; B01D 61/16

(52) U.S. Cl. CPC C02F 3/286; C02F 1/442; B01D 61/147; B01D 61/145; B01D 61/027; B01D 61/025; C02F 3/2853; B01D 61/04; C02F 9/00; C02F 3/30; B01D 61/58; C02F 3/006; B01D 61/16; C02F 3/2833; C02F 3/2826

(57) ABSTRACT

A biological reactor system treats concentrated contaminated water with a combination of upflow and downflow bioreactors that are downstream from a reverse osmosis or other concentrator. The system may have a fail safe configuration where flush water may be introduced to the reactors in the event of a power failure or when taking the reactors offline. Many reverse osmosis systems introduce antiscalant treatments upstream so that the reverse osmosis filters do not scale. However, such treatments result in superconcentrated conditions of the antiscalants in the contaminated water processed by the bioreactors. A flushing system may deconcentrate the bioreactors to prevent the antiscalants from precipitating and fouling the bioreactors.

### CROSS REFERENCE TO RELATED APPLICATIONS

This application claims priority to and benefit of U.S. patent application Ser. No. 15/291,050 “Fail Safe Flushing BioReactor for Selenium Water Treatment”, which is a Continuation In Part application, claiming priority to U.S. patent application Ser. No. 14/210,325 “Water Treatment System and Method for Removal of Contaminants Using Biological Systems” filed 13 Mar. 2014, U.S. patent application Ser. No. 14/210,310 “Water Treatment System and Method for Removal of Contaminants Using Biological Systems” filed 13 Mar. 2014, U.S. patent application Ser. No. 13/803,904 “Dual Stage Bioreactor System for Removing Selenium from Water” filed 14 Mar. 2013, U.S. Patent Application Ser. No. 61/842,381 “Advanced Packed Bed Bioreactor for Dissolved Contaminant Removal from Water” filed 3 Jul. 2013, and U.S. Patent Application Ser. No. 61/842,382 “Advanced Packed Bed Bioreactor for Dissolved Contaminant Removal from Water” filed 3 Jul. 2013, the entire contents of which are hereby expressly incorporated by reference for all they disclose and teach.

### BACKGROUND

Bioreactors are used to process water and other liquids. In many cases, bioreactors may be used to remove unwanted or harmful compounds from water. One such system may remove selenium from water, such as effluent from mining or other operations.

Many industrial activities involve processes that produce an effluent containing contaminants, which at elevated levels are toxic or otherwise detrimental to human health, fish and wildlife. Some anthropogenic sources of contaminated effluent include mining, coal fired power plants, agricultural drainage, oil refining, and natural gas extraction. Effluent contaminants may include soluble metalloids, soluble metals, soluble metal complexes, perchlorate, methyl mercury, arsenic, nitrates, and nitrites.

For example, selenium is a naturally occurring metalloid, which can be released through anthropogenic activities such as mining and the combustion of coal. Dissolved forms of selenium, selenate and selenite, have been known to bio-accumulate in birds and fish, causing mutations and death. Selenium in small amounts is an essential nutrient for fish and other wildlife, but at high levels, may be toxic.

Excessive levels of nitrate in drinking water may have a negative impact on the health of human infants and animals. Nitrate poisoning may affect infants by reducing the oxygen carrying capacity of the blood. The resulting oxygen starvation can be fatal. Once a water source is contaminated, the costs of protecting consumers from nitrate exposure can be significant.

Perchlorate, in large amounts, may interfere with iodine uptake into the thyroid gland. In adults, the thyroid gland helps regulate the metabolism by releasing hormones, while in children the thyroid helps in proper development.

Mercury may negatively affect the immune system, alter genetic and enzyme systems, damage the nervous system, and impair coordination and the senses of touch, taste, and sight. Indeed, fish consumption advisories for methylmercury now account for more than three quarters of all fish consumption advisories in the United States.

Arsenic may also be toxic to animals, including humans, and is a known carcinogen associated with both skin and lung cancers. Contamination of potable water supplies with arsenic is of particular concern.

The United States Environmental Protection Agency (EPA) commonly regulates and provides guidelines regarding contaminant levels that may or may not be acceptable for discharging effluent and water for release into potable water supplies. Complying with EPA requirements and guidelines can be difficult and expensive. Moreover, in the future the EPA may tighten or increase regulations governing contaminants in water for discharge or release into potable water supplies.

In the past, various methods have been employed for removing certain contaminants from industrial effluent. Three conventional methods that have been used include iron co-precipitation, activated alumina treatment, and biological treatment. Biological treatment of industrial effluent has emerged as one of the more popular means of removing these contaminants.

Biological treatment of contaminated water is commonly conducted using a bioreactor system. Bioreactors used in industrial effluent treatment may include suspended growth bioreactors, fixed bed reactors, and fluidized bed reactors. A fixed bed reactor may also be referred to as a packed bed bioreactor. A fluidized bed reactor may also be referred to as an FBR.

A bioreactor may be used to reduce a soluble contaminant to an elemental precipitate or to a gas form that is more easily removed from the water. Reduction of soluble contaminants may be accomplished by bacterial reduction.

For example, bacteria colonies cultured in bioreactors may be used to convert contaminants such as nitrates into gas, which may be more easily removed from the system than the oxidized form. Heterotrophic bacteria may utilize the nitrate as an oxygen source under anoxic conditions to break down organic substances resulting in nitrogen gas as one of the end products. Perchlorate may also be converted to the chloride ion (Cl—) and arsenic converted to As(III) using bacterial reduction by way of a bioreactor.

Thus, bioreactors may provide an environment in which to grow and maintain bacterial cultures cultivated for reduction of a contaminant. The bioreactors may include an insoluble support or growth media to provide a surface area on which bacteria may colonize and form biofilm. The insoluble support or growth media may comprise granular activated carbon (GAC), sand, or similar insoluble media conducive to growth, development, and adherence of a bacteria colony and biofilm. Both fixed bed reactors and fluidized bed reactors may use granular activated carbon (GAC), sand, or similar insoluble media for maintenance of biofilms.

A biofilm (sometimes referred to as a bacteria biofilm or active biofilm) is a complex biological structure comprised of colonies of bacteria and other microorganisms, such as yeast and fungi. Water and other liquids passing through a bioreactor may be maintained in regular contact with the biofilm when the bacteria colony and biofilm are disposed on an insoluble support or growth media.

Thus, soluble contaminants may be precipitated or converted to a gas form using a bacterial reduction process by passing water through a bioreactor where contaminants in the water come into contact with a biofilm specifically cultivated for reduction of a contaminant. Conventional bioreactor systems have typically been configured to permit flow of contaminated water through the system so that contaminants come into contact with the biofilm.

For example, bioreactors for removing soluble selenium from effluent may comprise specially cultivated bacteria colonies disposed within GAC, sand, or a combination thereof, where the bacterial colonies form a biofilm. Bacteria are fed carbohydrate rich nutrients, which are directly supplied to the bioreactor to stimulate bacterial respiration and biofilm growth.

Soluble selenium, typically an oxidized form of selenium such as Se042- (selenate) and Se032- (selenite) may be transformed to particulate elemental selenium using reduction by selenate or selenite bacterial respiration. Particulate elemental selenium may also be referred to as filterable selenium, colloidal selenium, fine elemental selenium particles, reduced elemental selenium particles, elemental selenium precipitate, or precipitate where the precipitate is a substance in solid form that separates from solution.

Reduction of selenate or selenite to elemental selenium particles occurs as water contaminated with selenate or selenite passes across the biofilm and the selenate or selenite is used in bacterial respiration. Selenate and selenite are very small particles typically less than 1 uM in size. When precipitated into elemental selenium particles, larger precipitated particles may be retained within the bioreactor while the water continues to pass through and out of the bioreactor system.

Similarly, bioreactors may be used to cultivate bacteria colonies disposed in GAC, sand, or some other insoluble growth media and convert contaminants, such as nitrates, to gas. As nitrate contaminated water passes through the bioreactor and comes into contact with the biofilm, the bacteria colony may use the nitrate as an oxygen source under anoxic conditions to break down organic substances and convert the nitrate into nitrogen gas in the process. Thus, nitrate may be converted to nitrogen gas by bacterial reduction. Perchlorate may also be converted to the chloride ion (Cl—) and arsenic converted to As(III) in a bioreactor using bacterial reduction.

However, there are some disadvantages to bioreactor systems currently available for remediating industrial effluent. For example, bioreactor systems are directly fed a carbohydrate nutrient to stimulate bacteria growth and respiration; and, the large amounts of carbohydrate nutrient may not be completely consumed. Unconsumed carbohydrate nutrient may reduce effluent quality. Consumption of carbohydrate nutrient may also result in increased carbonaceous (organic) compounds or particulate matter in the effluent, reducing water quality. The measurement of water quality based on carbonaceous compounds/organic matter in the water may be measured by determining the Chemical Oxygen Demand (COD) or the Biological Oxygen Demand (BOD). (BOD and COD are also sometimes used to refer to the carbonaceous compounds/organic matter in the water.)

Furthermore, conventional bioreactor systems do not effectively retain precipitates such as fine selenium particulates, thus reducing quality of effluent exiting the system.

Also, specific combinations of contaminants are of interest to certain industries. For example, recently proposed effluent guidelines for the steam electric power industry limit discharge of nitrate, selenium, mercury and arsenic. However, conventional bioreactors may not contemporaneously remove multiple species of contaminants effectively, particularly where bacterial reduction of different contaminant species may produce different end product forms (e.g., precipitate versus a gas).

There are also other disadvantages to conventional bioreactor systems. Fixed bed reactors tend to be large in size due to low hydraulic loading requirements necessary for solids retention. Biological reactions within the bed produce gases such as nitrogen, carbon dioxide, and hydrogen sulfide through cellular respiration and fermentation reactions. Gas can build up in the bed, decreasing bed permeability and creating head-loss, impeding water flow through the bed.

Some fixed bed reactors currently being used in the industry attempt to address decreased bed permeability by increasing the liquid level above the bioreactor bed, thus increasing the driving hydraulic head needed to push liquid through the bioreactor bed. The driving hydraulic head (sometimes referred to as static head) may be increased by increasing the column of water above the bioreactor bed. The maximum amount of static head available may be limited by the tanks height and available freeboard above the bioreactor bed.

Freeboard is the extra space needed above the reactor bed to meet the hydraulic head requirement for effectively pushing water through the bed. The bioreactor tanks must be tall enough so the driving head is sufficient to overcome gas entrained in the bed, which may prohibit permeation. Freeboard may account for as much thirty percent (30%) or more of additional tank height above what is required for the bioreactor bed.

The increased height and large volume of fixed bed reactors generally makes them more expensive, harder to transport, and if housed in a building, may require more building height. Moreover, because of their large size, fixed bed reactors typically have to be constructed onsite, which increases construction costs.

Attempts have also been made to reduce problems associated with gas impediment using fluidized bed reactors. In a fluidized bed reactor, water is passed through a granular solid material at high enough velocities to suspend the granular material so it behaves as though it were a fluid. This process, known as fluidization, assists in the release of gas.

However, a fluidized bed has some disadvantages because of the fluidization and extreme agitation in the system. For example, a fluidized bed reactor does not effectively remove particulate matter such as colloidal selenium and mercury species. Moreover, there is a resulting increase in organic materials in the effluent. Consequently, fluidized bed reactors require recycling the effluent through the bioreactor using multiple passes in order to remove contaminant particulates.

Thus, it is desirable to have an improved biological system and method for the treatment of water that improves the quality of the effluent exiting the system, more effectively retains particulate elemental contaminants, improves permeability of a bioreactor bed and associated water flow, reduces problems associated with entrained gases, effectively reduces COD/BOD in the effluent, provides for concurrent removal of various contaminant species, reduces freeboard above a bioreactor bed, and allows for a smaller overall system footprint.

### SUMMARY

A biological reactor system treats concentrated contaminated water with a combination of upflow and downflow bioreactors that are downstream from a reverse osmosis or other concentrator. The system may have a fail safe configuration where flush water may be introduced to the reactors in the event of a power failure or when taking the reactors offline. Many reverse osmosis systems introduce antiscalant treatments upstream so that the reverse osmosis filters do not scale. However, such treatments result in superconcentrated conditions of the antiscalants in the contaminated water processed by the bioreactors. A flushing system may deconcentrate the bioreactors to prevent the antiscalants from precipitating and fouling the bioreactors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a multistage water treatment system.

FIG. 2 is a diagram illustration of an embodiment showing a anaerobic bioreactor.

FIG. 3 is a flowchart diagram of an embodiment showing a method for treating water with dissolve selenium.

FIG. 4 is a diagram illustration of an embodiment showing a multistage water treatment system with filtration.

FIG. 5 is a diagram illustration of an embodiment showing an upflow bioreactor.

FIG. 6 is a diagram illustration of an embodiment showing a two stage water treatment system.

FIG. 7 is a diagram illustration of an embodiment showing a multistage water treatment system.

FIG. 8 is a diagram illustration of an embodiment showing a downflow bioreactor.

FIG. 9 is a diagram illustration of an embodiment showing a graph of vacuum pressure verses time for the output pump of a downflow bioreactor.

FIG. 10 is a diagram illustration of an embodiment showing a downflow bioreactor.

FIG. 11 is a diagram illustration of an embodiment showing a multistage water treatment system with a reverse osmosis concentrator.

FIG. 12A is a diagram illustration of an embodiment showing a set of upflow and downflow bioreactors during normal operation.

FIG. 12B is a diagram illustration of an embodiment showing a set of upflow and downflow bioreactors during a flush operation.

FIG. 12C is a diagram illustration of an embodiment showing a set of upflow and downflow bioreactors during a deconcentrator operation.

FIG. 13 is a flowchart illustration of an embodiment showing a method for operating bioreactors.

FIG. 14 is a flowchart illustration of an embodiment showing a method for a backwash sequence in bioreactors.

### DETAILED DESCRIPTION

Fail Safe Flushing BioReactor

A biological reactor system with a combination of upflow and downflow reactors has a fail safe configuration where flush water may be introduced to the reactors in the event of a power failure or otherwise when taking the bioreactors offline. The flush water may be gravity fed into the reactors and may dilute the reactors to the point where media and biological agents to not solidify and make restarting the bioreactor difficult. During normal operation, the reactors may process incoming water, which may keep the systems in balance, as the biological agents may consume material in the incoming stream and may release gasses as well as solids that may be suspended or dissolved in the effluent.

When the incoming water stream may be halted, such as in a power failure or when taking the bioreactor offline, antiscalants added to protect a reverse osmosis filter may be present in superconcentrated conditions. A flushing reservoir may be configured to open and backflush the reactors to deconcentrate the bioreactors to prevent unwanted precipitation of the antiscalants.

A biological reactor system for treating water may contain media on which biological agents may attach. The biological agents may be bacterium, algae, fungus, or other agents, and the media may be any mechanical media such as carbon.

During normal operation, the biological reactor system may use upflow or downflow reactors to treat water. Some systems may use a combination of reactors in series, such as an upflow reactor followed by a downflow reactor, or vice versa. In an upflow reactor, water may be introduced into the bottom of the reactor and may flow upward to a weir or other mechanism to receive the reactor effluent. In a downflow reactor, water may be introduced to the top of the reactor and may flow downward to an exit port.

Biological reactors may often operate with a periodic cleaning cycle, where water may be introduced into the reactor in a way that may clean the reactor by removing excess biological material, entrained gasses, dissolved or precipitated solids, or other matter from the reactor. Such a cleaning cycle may produce waste water that may be collected separately and further processed.

Several different types of cleaning cycles may be used. One type of cleaning cycle may be to flush a reactor with a large volume of water. Such a reactor may operate with a relatively low water flow rate, and in many cases the flow rate may be set to be a plug flow or laminar flow. Such a flow rate may allow the biological agents and their media to react with the water for a desired period of time. During a flush cycle, a much higher flow rate may be introduced. The high flow rate of the flush cycle may cause turbulent flow within the reactor, and may cause the media and biological agents to rub on each other, thereby mechanically separating or cleaning the media from excess biological material. The high flow rate may cause entrained gasses to be expelled, and in some cases, the high flow rate may capture and remove precipitates or other solid material from the reactor.

Some flushing cycles may be reverse flow flushing cycles. For example, a downflow reactor may have flushing water introduced into the bottom of the reactor, such as through what would be the normal output of the reactor. Such a reverse flow may loosen any media, precipitated solids, or other material in the reactor.

In the case of a downflow reactor, a flush cycle may be a reverse flow flushing cycle. In the case of an upflow reactor, a flush cycle may be a forward flow flushing cycle.

The net effect of a flushing or cleaning cycle may be to remove excess biological agents, as well as precipitates, entrained gasses, and other dissolved materials. During normal operation, a cleaning cycle may be performed as the reactor's effectiveness or efficiency changes. A reactor's efficiency or effectiveness may change as precipitates build up, as the biological agents grow, age, or die, or as media breaks down, nutrients are consumed and replenished, or other factors occur.

In some cases, a flushing cycle may introduce nutrients, new biological agents, or other items, such as conditioning agents such as anti-foaming agents, foam-enhancement agents, surfactants, solvents, or other agents that may clean, fortify, or otherwise prepare the reactor for further use.

A flushing cycle may be automatically performed when power may be cut to the system. The flushing cycle may dilute or otherwise perform some amount of cleaning of a reactor. The flushing cycle may reduce biological activity to the point where components in the reactor do not congeal, solidify, or otherwise make the reactor hard to restart.

The emergency flushing cycle may leave much of the biological agents, their nutrients, media, and other components in the reactor, but may lower the activity within the reactor. The reduction of activity may allow for service technicians to get the system back on line before the reactor may become unusable due to the solidification of the material in the reactor.

One use of a flushing cycle may be in the processing of reverse osmosis waste stream. The waste stream may be a concentrate, which may be further processed in a bioreactor or series of bioreactors. Such concentrate may have a high amount of salts and other contaminants, and in many cases, such contaminates may be supersaturated in the presence of anti-scaling agents. A flushing cycle may deconcentrate the material in the bioreactors, thereby eliminating the possibility of scaling within the bioreactors.

Two Stage Water Treatment Systems

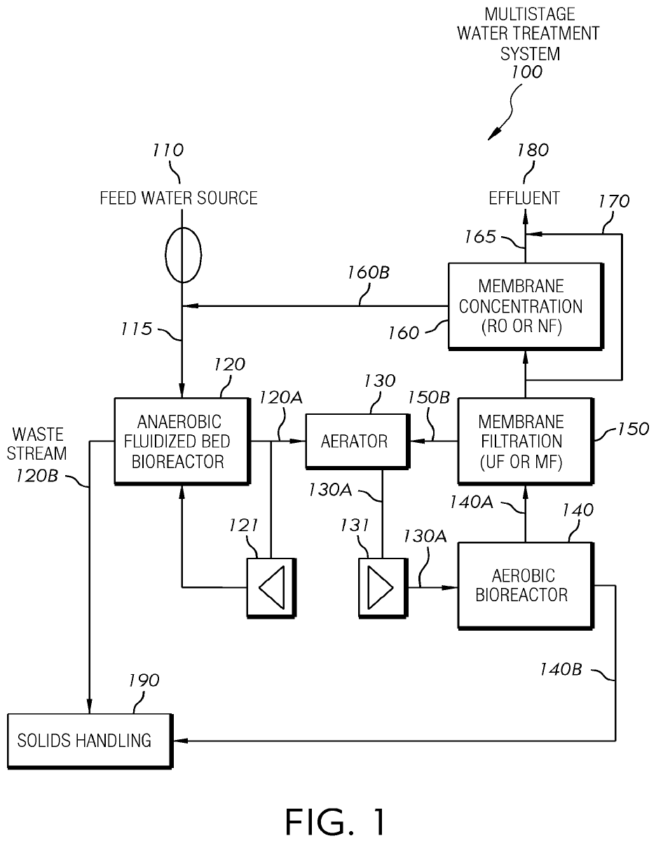

FIG. 1 is a diagram illustration of an embodiment 100 of a biologically active, multi-stage water treatment system. The system may be used to remove soluble selenium from contaminated water using reduction occurring during a first bioreactor where anoxic bacterial respiration reduces selenium and other water contaminants from a soluble form to a precipitate form. As a precipitate, the contaminants may be more easily removed from the water. A subsequent bioreactor stage operating under anaerobic, aerobic, or partially aerobic conditions may remove residual nutrients, which may permit subsequent membrane filtration and membrane concentration stages without membrane fouling.

The water treatment system 100 may receive contaminated water from a contaminated effluent from a feed water source 110. The feed water may be contaminated with soluble (oxidized) forms of selenium such as selenate or selenite, which may be toxic to fish and other wildlife. The feed water source 110 may be a river, pond, lake, or other contaminated water source. The feed water source 110 may include a contaminated water output of an industrial plant or process. The feed water source may also be a conduit, a holding tank, or a reservoir receiving contaminated water from industrial processes, such as mine runoff, coal-fired power plant effluents, a groundwater seep, well, agricultural drainage or other anthropogenic sources.

The water treatment system 100 may comprise an anaerobic bioreactor 120 at a first stage, an aerator 130 at a second stage, and one or more aerobic bioreactors 140 at a third stage for polishing. Bioreactors 120 and 140 may be configured to be biologically active. The anaerobic bioreactor 120 shown in FIG. 1 may be a fluidized bed reactor (“FBR”).

The multi-stage water treatment system 100 may also include a membrane filtration system 150 at a fourth stage for removal of residual precipitated selenium. The membrane filtration system 150 may remove, concentrate, and recover any remaining particulates that may be measured as Total Suspended Solids. The membrane filtration system 150 may comprise an ultrafiltration system or a microfiltration system.

The multi-stage water treatment system 100 may also include a membrane concentration system 160 at a fifth stage for removal of any residual dissolved selenium. The membrane concentration system may comprise a reverse-osmosis system or a nano-filtration system. Dissolved selenium removed by the membrane concentration system may be delivered to the feed water pathway between the feed water source 110 and the anaerobic bioreactor 120 for introduction back into the water treatment system 100 for further processing.

A solids handling system 190 may handle precipitate, biomass, and other solids removed during water treatment at the anaerobic bioreactor 120 stage and the aerobic bioreactor 140 stage. The solids handling system may separate solids from water, and may have a settling tank, clarifier, settling pond, or other solids removal mechanism.

The anaerobic fluidized bed reactor 120 may have a recycle system 121 to continually fluidize the media at a desired flow rate. The recycle system 121 may allow for additional reduction of dissolved selenium and reduce the amount of dissolved selenium escaping to the next stage of the water treatment system. The anaerobic fluidized bed reactor 120 may include one FBR or two smaller FBRs to conserve height when freeboard is limited. The anaerobic reactor flow rate may be about 12 to 15 gpm/ft2 with a recycle design. A recycle reactor may provide very long contact times for water being processed.

Dissolved selenium may be changed to particulate elemental selenium on the anaerobic bioreactor 120. The particulate elemental selenium may be filterable at this stage, and may integrate with biomass inside the anaerobic bioreactor 120 to form a solid. The solid may be transferred to a solids handling system 190. The solids may be extracted as a sludge-like biomass material.

The elemental selenium/biomass combination may be filtered, removed, and transferred through a waste stream 120B to the solids handling system 190 as a biomass waste product and later may be removed from the site for further processing or disposal.

After solids are removed from feed water treated in the anaerobic bioreactor 120, the treated water may be directed through a feed-water pathway 120A to an aerator 130 disposed between the aerobic bioreactor 120 and one or more aerobic or partially aerobic bioreactors 140 at a dynamic polishing stage. The water treated in the anaerobic bioreactor 120 may contain residual selenium and organic compounds (measured as COD/BOD). Residual organic compounds may foul membrane modules making membrane filtration unfeasible. Dynamic polishing 140 may assist removal of residual COD/BOD to prevent or minimize membrane fouling. By managing dissolved oxygen levels in water prior to delivery of water to the one or more aerobic or partially aerobic bioreactors 140, the dynamic polishing stage 140 may be optimized to improve removal of carbonaceous matter while minimizing oxidizing and re-dissolving of residual selenium precipitate.

The aerator 130 may be a packed column, diffuse bubble aeration, or other aeration device. The aerator 130 may be used to introduce dissolved oxygen into the feed water stream from the upstream anaerobic bioreactor 120. The level of oxygen introduced to the stream can be varied from 0 to 14 mg/L to a desired set point. A typical oxygen set point may be between 2 and 8 mg/l of oxygen. Dissolved oxygen levels may be optimized to balance a desired increase in consumption of residual carbon nutrient and increased production of biomass to be filtered at the dynamic polishing stage 140 with a desired low level of selenium precipitate oxidizing and re-dissolving into the water.

After aeration of treated water at the aeration stage 130, water may be directed through a feed water pathway 130A into one or more aerobic or partially aerobic bioreactors 140 for dynamic polishing to prepare the water for downstream membrane filtration. The aerobic bioreactor 140 may include a recycle system to fluidize growth media inside the bioreactor at a desired flow rate and or help control dissolved oxygen levels.

The aerobic bioreactor 140 comprising the dynamic polishing system may include one or more fluidized bed or one or more fixed bed bioreactors, which may be known as a packed bed bioreactor. A fixed bed bioreactor may be comprised of a bioreactor housing and a packed bed comprising a growth media suitable for development of a bacteria colony thereon. In many cases, the growth media in the aerobic bioreactor 140 may be similar to or the same as growth media used in the anaerobic bioreactor 120, such as granular activated carbon (“GAC”), 30-90 mesh silica, sand, a combination thereof, or other soluble or insoluble growth media.

Unlike the fluidized bed of the anaerobic bioreactor 120, the packed bed of a fixed bed aerobic bioreactor 140 may not be fluidized and may act as a media filter for removal of biomass and residual selenium precipitate.

Some embodiments may use a dynamic polishing system in place of the aerobic bioreactor 140, where the dynamic polishing system may operate in complete anaerobic mode with no aeration, partial aerobic mode having partial aeration, or full aerobic mode with maximum aeration depending on the level of dissolved oxygen introduced in the water at the upstream aeration system 130.

Aeration may be controlled by monitoring levels of dissolved oxygen using a dissolved oxygen sensor. Oxygen levels may be measured within bioreactors 140 of the dynamic polishing system, or at the effluent stream 140A of the dynamic polishing system. Air flow may be adjusted upstream at the aeration stage 130. Air flow adjustment may be controlled by a programmable logic controller providing control signals to the aeration system in response to data received by the programmable logic controller from the dissolved oxygen sensor. The amount of dissolved oxygen in the dynamic polishing step can be adjusted in the range of 0 to 14 mg/L dissolved oxygen.

Biomass and precipitated selenium/biomass solids produced or retained in the dynamic polishing system 140 may be transferred to a solids handling system 190 through a waste stream channel 140B and later may be removed from the site for further processing or disposal.

After water has been treated by the dynamic polishing system 140, water may be directed to a membrane filtration system 150 for removal of residual selenium precipitate. The membrane filtration system may be a membrane bioreactor, a microfiltration filter, or an ultrafiltration filter. The membrane filter 150 may be an ultrafiltration membrane filter having a pore size of between about 0.1 to about 0.001 microns. In another embodiment, the membrane filter 150 may be a microfiltration membrane filter having a pore size of between about 0.1 to about 3 microns. Water filtered by the membrane filtration system 150 may produce a clean permeate stream 150A and or a concentrate stream 150B. The clean permeate stream may be discharged from the water treatment system 100 as clean effluent 170.

The concentrate stream may be recycled to the aerator 130 or may be channeled to a membrane concentration system 160 for further filtering of water treated by the water treatment system. The membrane concentration system may comprise a reverse osmosis filter system or nanofiltration filter system.

Water filtered by the membrane concentration system 160 may also produce a clean permeate stream 165 and a concentrate stream 160B. The clean permeate may be discharged as clean effluent 180. The concentrate stream 160B containing residual dissolved selenium may be fed back to the feed water pathway 110 at the beginning of the water treatment system 100 for additional treatment.

The membrane concentration system 160 may include a bypass line 170, which allows for 0 to 100% of the flow from the downstream membrane filtration system 150 to be directed to the membrane concentration system 160. The fraction of water 150A from the membrane filtration step 150 that is not sent to the membrane concentration step 160 may be discharged as clean effluent 180 via the bypass line 170. Clean effluent discharged from the water treatment system after treatment of the feed water for selenium removal may be suitable for surface discharge, as opposed to human drinking water.

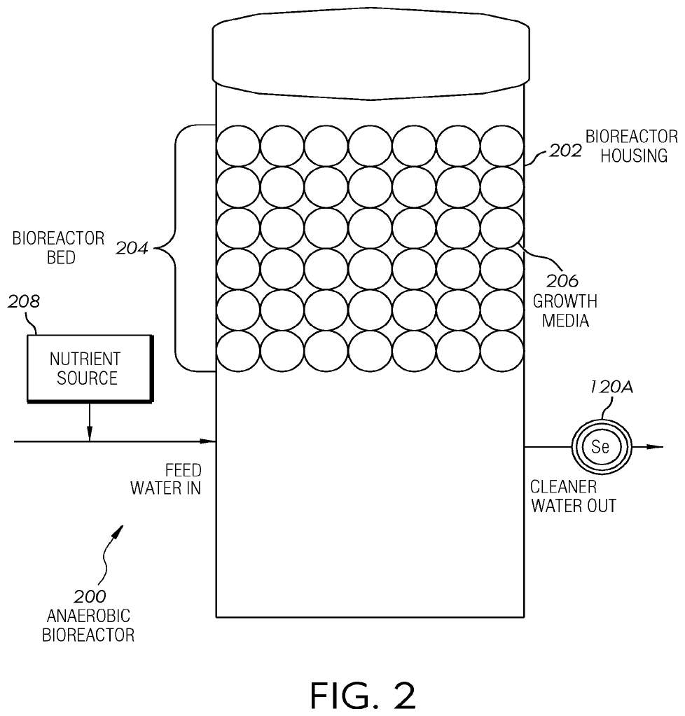

FIG. 2 illustrates a conceptual diagram of an embodiment 200 showing an anaerobic bioreactor, such as the anaerobic bioreactor 120. The bioreactor may be comprised of a bioreactor housing 202 containing a bioreactor bed 204. The bioreactor housing 202 may be made of concrete, fiberglass, HDPE, steel, or other suitable material.

The bioreactor bed 204 may be comprised of an growth media 206 suitable for development of a bacteria colony thereon. Bacteria may colonize on the surface of the growth media 125, which may provide a high surface area for biofilm formation. The growth media 125 may include granular activated carbon (“GAC”), 30-90 mesh silica, sand, a combination thereof, or any other growth media. In many cases, the growth media may be insoluble growth media. It is understood that the term insoluble growth media may include growth media that is substantially insoluble.

The bioreactor bed 204 may be fluidized by passing water through the granular growth media 206 at high enough velocities to suspend the granular material so it behaves as though it were a fluid. Fluidization of the bioreactor bed 204 may require recycling of effluent at a hydraulic loading rate of 2 to 5 gpm/ft2.

The bioreactor of embodiment 200 may be operated under anaerobic conditions so that bacteria forming the biofilm may engage in anoxic or anaerobic respiration. The fluidized bed bioreactor may have a nutrient source 208, which may inject a nutrient to stimulate bacterial growth and respiration. The nutrient may be comprised of acetate, glucose, molasses, methanol, or other nutrient sources. In many cases, the nutrient may be a carbon based nutrient. In some cases, the nutrient source 208 may be a liquid injection system that may periodically inject nutrient to the incoming water stream.

Feed water entering the bioreactor and passing through the fluidized bed may come into contact with a biofilm of bacteria colonies engaged in anaerobic respiration. Dissolved selenium, such as selenate or selenite, coming into contact with such a biofilm may be transformed to a selenium precipitate through bacterial reduction. Selenium precipitate may then be suitable for filtration.

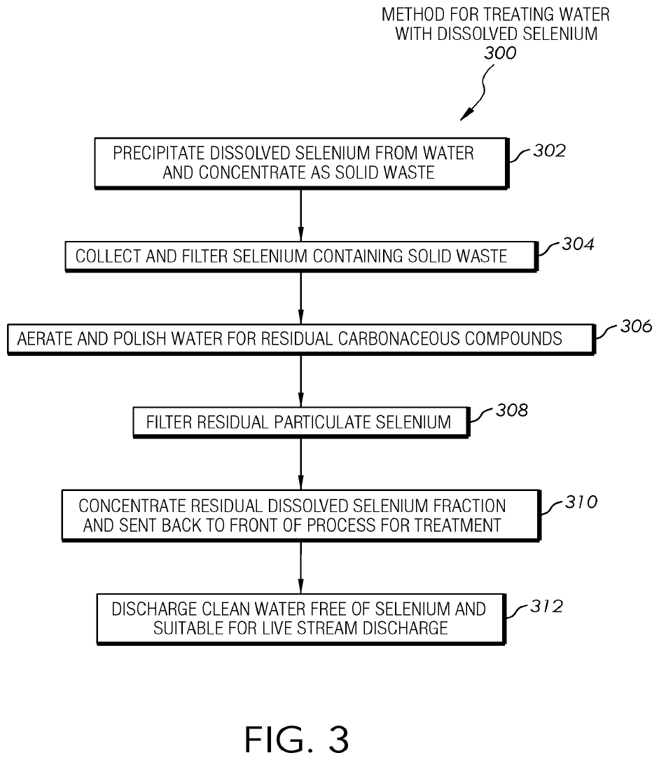

FIG. 3 is a flowchart illustration of an embodiment 300 showing a series of steps for removing soluble selenium using a water treatment system.

In block 302, dissolved selenium is precipitated and concentrated as solid waste. This step may be performed using an upflow bioreactor, such as the anaerobic bioreactor 120, where dissolved selenium may be converted into elemental selenium as a precipitate. The precipitate may become entrained with and become concentrated in the biomass within the bioreactor 120. A recycle system 121 may periodically capture and remove excess biomass from the bioreactor 120 in block 304.

In block 306, the water may be aerated and polished to remove carbonaceous compounds. Such a step may be performed by an aerator 130 and aerobic bioreactor 140.

The residual selenium may be filtered in block 306. Some of the filtration may occur in the aerobic bioreactor 140, while other filtration may occur in the membrane filtration 150. Some systems may have a membrane concentrator 160, which may concentrate the residual selenium in block 310 and return the concentrate to the system for further processing.

The cleaned water may be discharged in block 312.

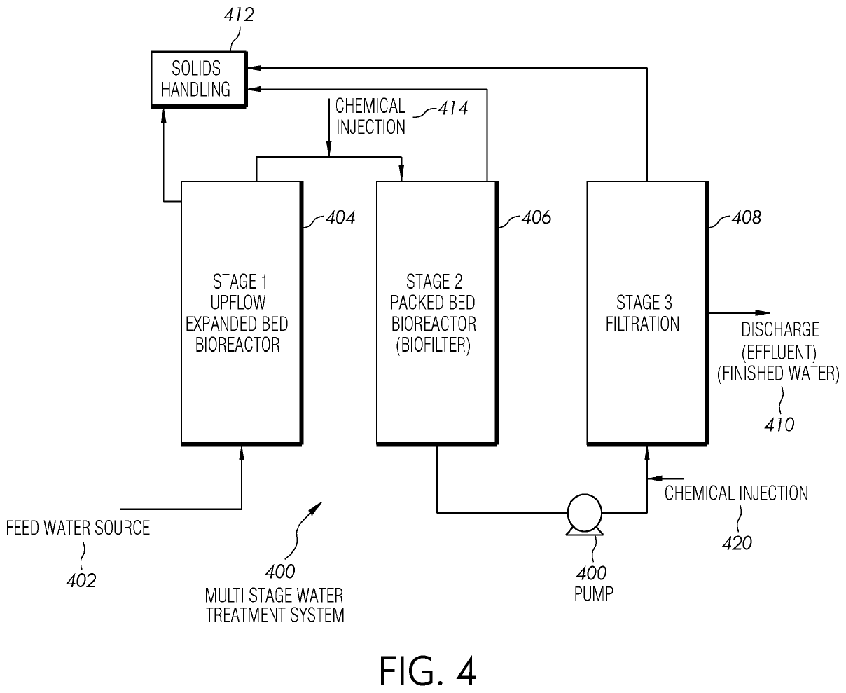

FIG. 4 is a diagram illustration of an embodiment 400 showing a biologically active water treatment system. A multi-stage water treatment system may have an upflow bioreactor 404 at a first stage, a downflow bioreactor 406 at a second stage, and a filtration system 408 at a third stage. The upflow bioreactor 404 may include an expanded bed. The downflow bioreactor 406 may include a packed bed. The downflow bioreactor 406 having a packed bed may be referred to as a downflow biofilter.

Many systems may be designed with multiple trains. In such systems, a single train may have a set of upflow and downflow bioreactors that may be operated together. Several trains may be used in parallel to treat large volumes of water. In many such systems, trains may be taken offline for servicing or for periods of reduced water flow.

The multi-stage water treatment system may include a solids handling system 412 for treating solids removed from water treatment system at one or more stages. The solids handling system 412 may receive solid waste from the upflow bioreactor 404, from the downflow bioreactor 406, or from the filtration system 408. The solids handling system 412 may have a settling tank, clarifier, settling pond, or other solids handling mechanisms.

Various features and operations of the water treatment system may be controlled or managed by a programmable logic controller (sometimes referred to as a PLC). The programmable logic controller may interface with a touch screen computer having a graphical display showing water treatment system modes, parameters, and systems.

The programmable logic controller may control or monitor a number of mechanical components of the water treatment system. For example, flow meters associated with water flow in water channels or conduits throughout the water system may send flow rate data to the programmable logic controller, including flow data associated with water flow at influent and effluent ports for each of the first and second stage bioreactors and for the filters and solids handling systems.

Automated valves may be provided which may be air actuated or electronically actuate may open and close to direct water for various modes of operation of the water treatment system, including service mode (e.g., treating the water), backwash mode, offline mode, startup, and taking bioreactor trains offline. Each operation may comprise a different valve configuration to direct water flow as needed for the mode operation. The programmable logic controller may send signal to open or close the automated valves and direct water flow for each mode of operation.

Flow control valves may be provided for adjusting water flow rate by partially opening or closing water channels, including for example influent and effluent ports. The flow control valves may open and close at variable parameters to meet a water flow set point. The flow control valves may open and close in response to communications received from the programmable logic controller. The programmable logic controller may control the opening and closing of the flow control valves in response to flow data received from flow meters. Thus the flow control valves may track to a set point.

Water pumps may also be provided, such as water pumps for driving feed water into the water treatment system, an effluent pump for pumping water out of a downflow bioreactor, and a backwash pump for pumping clean water back upward into a bottom of the downflow bioreactor and up through the packed bed for dislodging gas or for backwashing solids. The pumps may be fixed speed pumps with only on/off modes or may be variable drive pumps that operate at variable speeds between 0% and 100% to meet a water flow set point as measured by a flow meter. The water pumps may be operated or controlled by the programmable logic controller in response to communications or data received from various sensors, such flow meters and pressure gauges.

Pressure gauges may also be provided for measuring pressure and sending pressure data to the programmable logic controller. Pressure gauges, such as an effluent pressure gauge, may be disposed downstream of bioreactors to measure effluent pressure to track gas formation as a measurement of biological activity rate in a bioreactor bed. Effluent pressure may also be used to measure bed permeability.

The water treatment system may also include other instruments for measuring turbidity, pH, and oxidations reduction potential such as turbidity meters, probes that measure scattered light, electrode probes for measuring pH and oxidation reduction potential. Bed level may be measured using a sonar or ultrasonic sludge blanket detector and or using turbidity.

Turbidity data may also be used to measure filtration efficiency. Data from these instruments may be communicated to the programmable logic controller which may monitor or adjust water treatment system modes or operations in response to the data received.

A chemical metering pump may also be provided for injecting chemicals into channels where desired. The rate of chemical injection by the chemical metering pump may be regulated by the programmable logic controller in response to date received by the PLC from sensors such as flow meters.

Thus, many of the water treatment operations may be automated or controlled using a PLC. It should be understood that the programmable logic controller and other referenced valves, pumps, motors, gauges and other measuring devices may be used as desired in other embodiments as well.

Industrial effluent containing soluble selenium or other contaminants may be fed into the water treatment system from a feed water source and directed into the biologically active upflow bioreactor 404 for single pass treatment of the feed water. A carbon based nutrient may be introduced into the feed water before it is fed into the upflow bioreactor 404 to stimulate bacterial growth and respiration as it comes into contact with the biological colony growing in the upflow bioreactor bed. The feed water may mixed with a biological growth substrate, including macro nutrients such as carbon, nitrogen, and phosphorous and micro nutrients such as molybdenum, cobalt, zinc, and nickel which may be fed through the bottom of the reactor. It should be understood that other micro nutrients available to one skilled in the art may also be used.

The environment in the upflow bioreactor may be maintained in a substantially anaerobic condition to foster bacterial reduction. The water treatment system may be configured for about 80% reduction of soluble contaminants at the upflow bioreactor 404 stage. The expanded bed of the upflow bioreactor 404 may allow for concomitant release of gas and retention of particulate selenium.

After single pass treatment of feed water in the upflow bioreactor 404, the effluent may be directed through a water conduit to the downflow bioreactor 406 for further treatment. A chemical injection system 414 may be associated with the feed water pathway between the upflow bioreactor 404 and the downflow bioreactor 406. A chemical such as ferric chloride or an organosulfide may be introduced into effluent from the upflow bioreactor 404 to improve or increase reduction of soluble metals prior to biofiltration. Injection of ferric chloride or organosulfide into effluent from the upflow bioreactor 404 may promote coagulation of biological material in the downflow bioreactor 406. The rate of chemical injection may be regulated by communications to the chemical injection system from the programmable logic controller. The rate of chemical injection may be regulated in response to data received by the programmable logic controller from sensors such as flow sensors.

The downflow bioreactor 406 may include a biologically active packed bed for further reduction of any residual dissolved selenium or other reducible contaminants and may act as a biofilter for media filtering of any particulate selenium or other contaminant precipitate remaining in effluent from the upflow bioreactor 404. The downflow bioreactor 406 may also consume residual nutrient that may carry over from the upflow bioreactor 404 and convert it into biomass.

In some cases, no or little additional nutrient may be introduced into effluent after leaving the upflow bioreactor 404 so that carbon consumption in the downflow bioreactor 404 may be substantially complete. In some cases, the water treatment system may be configured for about 20% reduction of soluble contaminants at the downflow bioreactor 404 stage. An advantage of using a downflow bioreactor 406 to direct water down through a packed bed is improved retention of solids by the filtering action of the packed bed.

The configuration of a first upflow bioreactor 404 stage followed by a secondary downflow bioreactor 406 stage for biofiltration provides for a high quality water stream suitable for discharge or release into the environment. Such a system may produce a high quality effluent by decoupling the selenium reduction and solids removal, while polishing the water for residual COD/BOD removal.

An upflow bioreactor 404 with an expanded bed followed by a downflow bioreactor 406 having a packed bed allows for a smaller overall system footprint that other designs. The removal of gas by the upflow bioreactor 404 while retaining selenium or other contaminant precipitate allows for improved permeability of the downflow bioreactor 406 packed bed and thus reduces the hydraulic head needed to push water through the packed bed. Thus, the downflow bioreactor 406 at the second stage may be smaller compared to conventional fixed bed bioreactors which require a deep bed and long contact time to achieve both selenium precipitation and solids retention.

The downflow bioreactor 406 may have a downstream effluent pump 416 to pull water from the downflow bioreactor 406 down through the packed bed. Vacuum assisted transfer of water through the packed bed further reduces the hydraulic head need for pushing water through the packed bed, thus further allowing for a small downflow bioreactor 406 footprint and for an overall smaller water treatment system footprint.

An upflow bioreactor 404 with an expanded bed followed by a downflow bioreactor 406 having a packed bed may produce reduced COD/BOD in the effluent 410. The reduced COD/BOD allows for subsequent membrane filtration without substantial membrane fouling. The effluent water may also be suitable for direct discharge into ive streams and into fish and other wildlife habitats.

Effluent from the downflow bioreactor 406 may be directed through an effluent conduit to a filtration system 408 for further polishing of the effluent. The filtration system 408 may be a media, multimedia, membrane filtration, or other types of filtration systems. When treating power plant effluent, a typical system may use an ultrafiltration system or a microfiltration system. Such an ultrafiltration membrane filter may have a pore size of between about 0.1 to about 0.001 microns. Such a microfiltration membrane filter may have a pore size of between about 0.1 to about 3 microns.

Removal of contaminants such as dissolved selenium may be improved at the filtration stage 408 by use of a chemical injection system 420 associated with the feed water pathway between the downflow bioreactor 406 and the filtration system 408. A chemical such as ferric chloride or an organosulfide may be introduced into effluent from the downflow bioreactor 406 for increased reduction of soluble metals prior to filtration. The rate of chemical injection may be regulated by communications to the chemical injection system from the programmable logic controller. The rate of chemical injection may be regulated in response to data received by the programmable logic controller from sensors such as flow sensors.

Ultra-low levels of selenium precipitate (<5 ug/L total selenium) may be accomplished by membrane filtration of fine particulate selenium. In conventional selenium treatment bioreactors, the particulate selenium can escape the bed and contribute to selenium in the effluent. The reduction of effluent COD/BOD to facilitate membrane filtration without membrane fouling allows removal of escaped selenium precipitate from the effluent. The membrane filtration system may remove, concentrate, and recover any remaining particulates that may be measured as Total Suspended Solids.

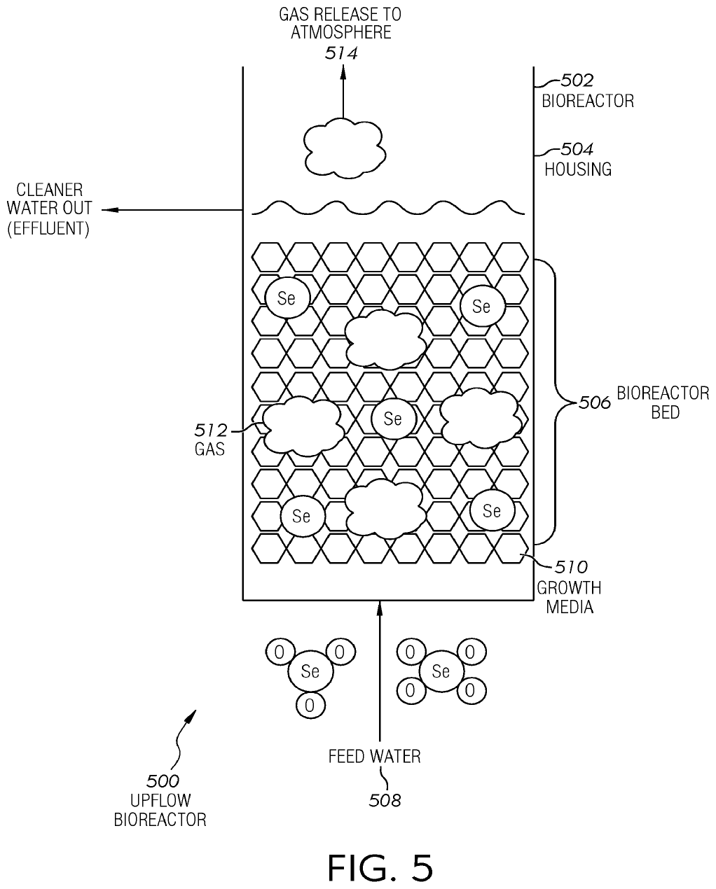

FIG. 5 illustrates an embodiment 500 showing an upflow bioreactor 502, which may be similar to the anaerobic bioreactor 120 or other upflow bioreactors illustrated herein.

The bioreactor 502 may have a housing 504 that contains a bioreactor bed 506. The bioreactor bed 506 may operate in an expanded bed formation, where the growth media 510 may be fluidized by the upward flow of water.

The bioreactor housing 504 may be made of carbon steel, coated carbon steel, stainless steel, fiberglass, or plastic. It should be understood that the bioreactor housings of the present invention may be made of any suitable material available to one skilled in the art, in addition to carbon steel, coated carbon steel, stainless steel, fiberglass, or plastic. The bioreactor housing may be made using molding, machine casting, or any other method available to one skilled in the art, which may depend on the material used to make the bioreactor housing 504.

The upflow bioreactor 502 may be configured for receiving feed water 508 from a lower region of the bioreactor bed 506 so that water may flow substantially upward through the bioreactor bed 506. The bioreactor bed 506 may be an expanded bed comprised of an insoluble growth media 510 suitable for development of a bacteria colony thereon. Bacteria may colonize on the surface of the insoluble growth media 510. The use of selected insoluble growth media 510 in the biologically active bioreactor may provide high surface area for bacterial biofilm formation. The insoluble growth media 510 may include granular activated carbon (“GAC”), 30-90 mesh silica, sand, or a combination thereof. In a preferred embodiment the insoluble growth media 125 may be GAC.

The expanded bed 506 of the upflow bioreactor 502 may be formed by channeling feed water 508 through the bottom of the upflow bioreactor 502 so that water is pushed or pulled evenly up through the insoluble growth media 510. The water may be evenly dispersed up through the bioreactor bed 506 using a water distribution system. In a preferred embodiment, the bioreactor bed 506 may be extended by pushing or pulling water up through the bioreactor bed 506 at a flow ranging from between about 2 to about 7 US gallons per minute per square foot (gpm/ft2) of tank area, or an upflow velocity of 25 to 60 feet per hour (ft/hr).

The upward flow may be adjusted to provide plug flow or laminar flow within the bioreactor bed 506, while being low enough that the growth media 510 does not flow out of the bioreactor 502. Operating with an upflow hydraulic loading rate of between about 2 and about 7 gpm/ft2 allows for gas resulting from biological activity to escape past the insoluble growth media 510 with the momentum of the water without disrupting the bed in a manner that may release substantial amounts of reduced selenium precipitate. The empty bed contact time (EBCT) of the upflow bioreactor 210 may vary from 5 minutes to 40 minutes depending on feed water temperature and the level of contaminant removal needed.

Bed expansion may vary between about 10% and about 40% of a static level and may be completed using a single pass flow with no recycle of the effluent to the upflow bioreactor 502 feed. Bed expansion may be measured using impedance spectroscopy or turbidity to evaluate the height of the bed. Impedance spectroscopy or turbidity may also be used to evaluate growth of the bioreactor bed 506 from biofilm growth and incomplete expulsion of gas. When the expanded bed reaches a specified height, impedance spectroscopy or turbidity sensors may trigger either a mechanical backwashing event that is used to remove a portion of the biofilm or a short pulse to release any entrained gas.

An upflow bioreactor 502 having an expanded bioreactor bed 506 may allow for concomitant release of gas and retention of precipitate. Furthermore, use of an upflow bioreactor 502 having an expanded bed 506 may allow improved reduction of contaminants while reducing expanded bed contact time and overall pre-discharge water treatment time without recycling effluent at the primary bioreactor.

Hydraulic loading rates greater or lower than the preferred range may not concomitantly accomplish of the benefits allowed by an expanded bed 506 configuration. Water flowing up through the bottom of a bioreactor bed at hydraulic loading rates equivalent to greater than 10 gpm/ft2 may fluidize the insoluble growth media 510 which allows for release of precipitated selenium from the bioreactor bed 506. A fluidized bed may require recycling the treated water to obtain optimal water treatment.

Alternatively, water flowing up through the bottom of a bioreactor bed at hydraulic loading rate velocities of less than 2 gpm/ft2 often results in a packed or fixed bed which tends to retain gas resulting from biological activity. A biologically active packed bed tends to lose permeability over time because of entrained gas.

In one or more aspects of the present invention, the influent water feed rate is controlled to a low enough level to optimize the benefits of plug flow, eliminating the recycle and concentration of waste products from the effluent of the upflow bioreactor 502, reducing impact energy between the particles, allowing for greater biomass retention, and allowing more effective removal of biomass/reduction precipitate matter from water before delivering effluent to subsequent stages of a water treatment system. The feed rate may be maintained at a high enough rate sufficient to expand the bed and allow release of gas 514 during treatment, which is not possible using the low non-fluidizing upflow velocities previously used in the industry. The gas 512 generated within the bed due to microbial respiration and fermentation may be released from the expanded bed 506 and carried to the top of the bed 506 and expelled as gas released to the atmosphere 514.

Over time, the expanded bed 506 level may increase because of bed growth caused by biology growth on the insoluble growth media 510. Growth of the bioreactor bed 506 may extend upward and begin to decrease the efficiency of the bioreactor 502 or interfere with effluent flow.

Bed growth may be automatically managed by periodic air scouring to remove biomass from the insoluble growth media. Air scouring may include blowing air into the expanded bed 506 through a diffuser to break up biomass accumulated on the insoluble growth media. A bypass valve may be provided in an effluent pathway at a downstream position from the upflow bioreactor for diverting biomass and carbonaceous matter to a waste or solids handling system during or shortly after air scouring.

The expanded bed 506 level may be measured by measuring turbidity using turbidity meter or probes that measure scattered light. The bed level of the expanded bed 506 may also be measured using a sonar or ultrasonic sludge blanket detector and or using turbidity. A programmable logic controller may control an air scour system and may turn the air scour system on or off in response to data received from turbidity sensors or from a sonar or ultrasonic sludge blanket detector. The air scour system may be disposed adjacent to the bioreactor bed and may be configured so that air may be flown into the insoluble growth media to remove accumulated biological matter or growth.

Thus, a significant advantage of configuring the bioreactor 502 with an expanded bed 506 is the ability to optimize hydraulic loading for retention of reduction precipitate and solids and the concomitant removal of gas from the bed. For example, the biological reduction of oxyanions such as selenate and selenite will produce nanoparticles. These submicron particles can more easily be retained within the bed by controlling the water flow rate to avoid bed fluidization while still operating the upflow bioreactor 502 just above the minimum upflow velocity for expulsion of gas.

Another advantage to the upflow bioreactor 502 being configured with an expanded bed is the ability to concurrently reduce multiple contaminant species from which reduction produces end products having different states of matter. For example, reduction of selenate and selenite results in a selenium precipitate (e.g., a solid); reduction of nitrate and nitrite results in nitrogen (e.g., a gas); and the reduction of perchlorate results in a soluble chloride ion. The use of an upflow bioreactor 502 configured with an expanded bed 506 may allow for the concurrent treatment of these and other contaminant species. The ability of the expanded bed 506 configuration to concurrently reduce various contaminant species having different end product forms may be facilitated by its ability to concomitantly retain reduction precipitate and biomass while releasing gas from the bed.

An upflow bioreactor 502 having an expanded bed 506 also provides for versatile water treatment system configurations that may utilize the benefits of the expanded bed configuration, including the ability to concurrently remove a combination of industrial effluent contaminants such as concurrent treatment of a combination of nitrate, perchlorate, selenium, or the concurrent pretreatment of nitrate, perchlorate, selenium, arsenic, or mercury.

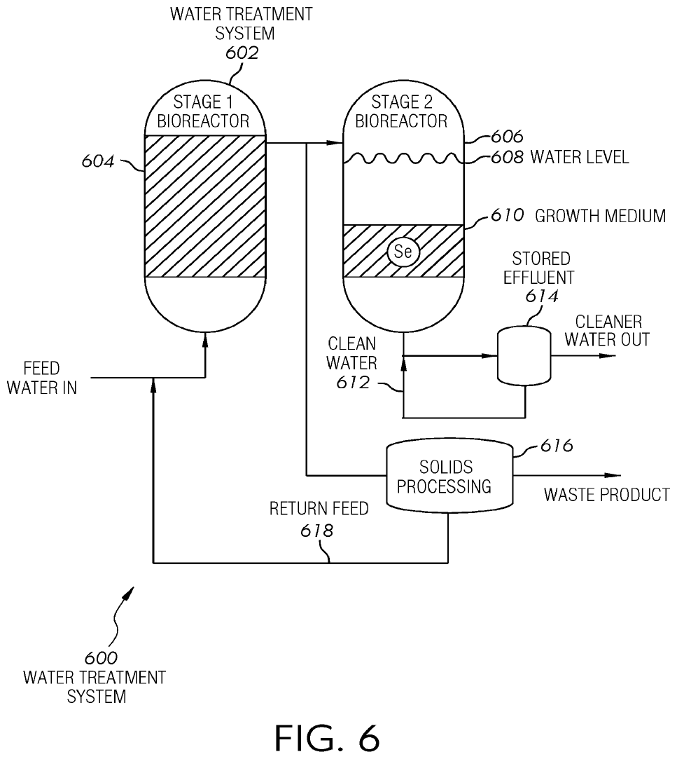

FIG. 6 is a diagram illustration of an embodiment 600 showing a water treatment system 602. The water treatment system 602 may have an upflow bioreactor 604 as a first stage and a downflow bioreactor 606 as a second stage.

The water level 610 in the second stage bioreactor 606 may be maintained at a consistent level by drawing effluent out of the bioreactor 606 with a effluent pump, or may be allowed to vary with the static pressure used to drive the water through a growth medium 610, such as GAC. The contact time of the second stage bioreactor 606 may be maintained in the range of 10 to 40 minutes wherein the second stage biofilter may receive effluent from the expanded bed bioreactor 604 without the addition of carbon nutrient to the water channeled to the second stage bioreactor 606. Channeling effluent to the second stage bioreactor 606 without adding additional carbon nutrient may culture a ‘stressed’ biofilm suitable for capturing and adsorbing any residual carbon material released from the first bioreactor 604.

Gas produced by biological activity in the second stage bioreactor 606 may remain trapped within the insoluble growth media 610 and biofilm matrix structure and may be periodically released. Degassing may be accomplished through a combination of hydraulic and or mechanical means. Gas may be released from the second stage bioreactor 606 by feeding a burst of clean water 612 into the bottom of the bioreactor 604 from a stored treated effluent 614.

Biofilm growth and bed permeability may be measured by monitoring the driving pressure across the bed in either static head or the vacuum level of the effluent. A pressure gauge may be used to measure the static head. In some case, an effluent pressure gauge may be used to measure the vacuum level of the effluent. The effluent pressure gauge may be a compound gauge that may measure both positive and negative pressure. When the pressure reaches a level that may limit the bioreactor 606 from operating at a desired flow rate, a backwash may be performed by feeding clean water 612 into the bottom of the bioreactor 606 from stored treated effluent 614. Solids removed from the growth medium 610 during the backwash event may be collected at the top of the bioreactor 606 and transferred to a solids handling system 616.

Solids may be dewatered by conventional means creating a solid waste product and a liquid stream that may be returned to the preliminary feed of the water treatment system 602.

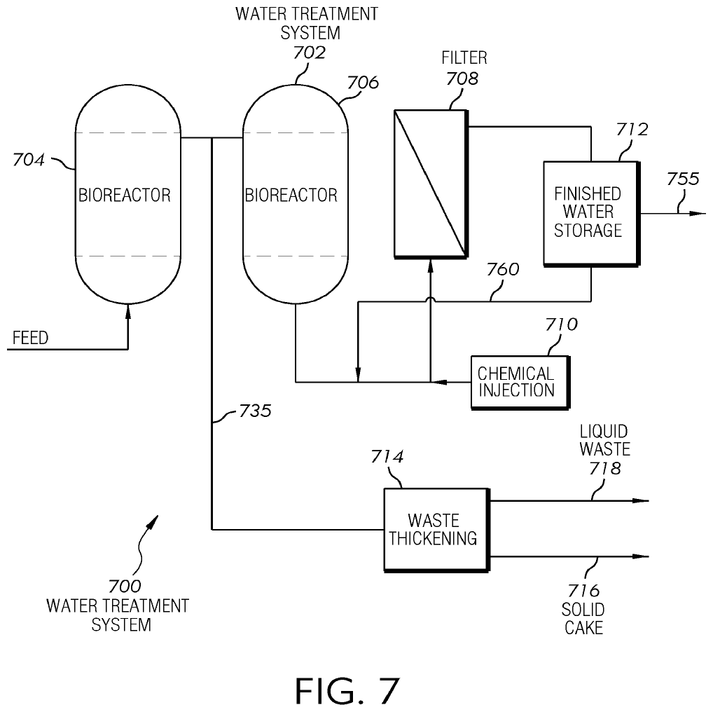

FIG. 7 is a diagram illustration of an embodiment 700 showing an example water treatment system 702 that may be suitable for the concomitant removal of nitrate, mercury, arsenic, and selenium to trace levels. In this embodiment, the primary bioreactor 704 and the secondary bioreactor 706 may be coupled to a tertiary filter 708. The tertiary filter 708 may be comprised of a dual media filtration system, microfiltration system, an ultrafiltration system, or other filter mechanism. A chemical injection 710 may introduce ferric chloride or organosulfide upstream of the filter 708. The chemical injection 710 may help with pH adjustment to optimize filter performance and metal precipitation. The addition of ferric chloride or organosulfide may promote precipitation of arsenic and mercury compounds previously reduced in the bioreactors 704 and 706.

Effluent from the filter 708 may be stored in a finished water storage tank 712 and used for periodic backwashing and degassing of both the secondary bioreactor 706 and the tertiary filter 708. In this embodiment, waste residuals may be thickened and dewatered in a solids handling system 714 in order to bind and collect any colloidal metal material. Solid or thickened cake 716 may be removed as a waste product and liquid waste 718 may be returned to the preliminary feed of the water treatment system 702, discharged directly into the environment, or a combination thereof.

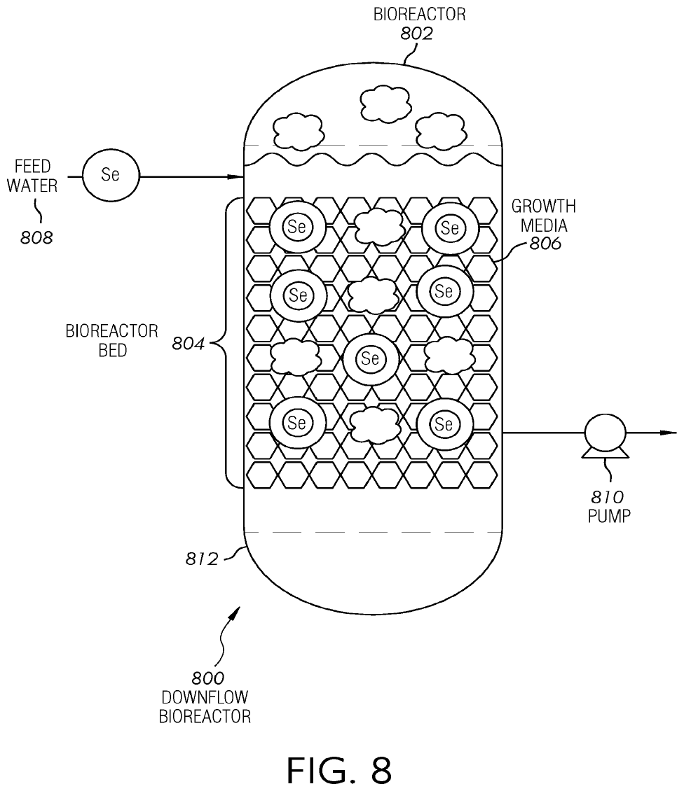

FIG. 8 is a diagram illustration of an embodiment 800 showing a downflow bioreactor 802. The bioreactor 802 may have a housing 804 and a bioreactor bed 806, which may comprise growth media 808.

The bioreactor housing 804 may be comprised of carbon steel, coated carbon steel, stainless steel, fiberglass, or plastic. It should be understood that the bioreactor housings of the present invention may be comprised of any suitable material available to one skilled in the art, in addition to carbon steel, coated carbon steel, stainless steel, fiberglass, or plastic. The bioreactor housing may be made using molding, machine casting, or any other method available to one skilled in the art, which may depend on the material used to make the bioreactor housing.

The bioreactor bed 804 may be configured as a packed bed and may be between about two feet and twenty feet in depth. Bacteria may colonize on the surface of the insoluble growth media 806 to form a biofilm. The use of selected insoluble growth media 806 in the biologically active bioreactor may provide high surface area for bacterial biofilm formation. The insoluble growth media 806 may include GAC, 30-90 mesh silica, sand, green sand, any other growth media, or a combination thereof.

The downflow bioreactor 802 may be configured to receive feed water 808 through an influent portal near an upper area of the bioreactor 802. The feed water may be pushed or pulled down through the downflow bioreactor 802 and through the packed bed 804 so that contaminants, such as selenate and selenite, and carbonaceous matter may come into contact with the biofilm in the biologically active bioreactor bed 804. Soluble contaminants may be transformed to precipitates via bacterial reduction. For example, soluble forms of selenium may be precipitated through biological reduction to a selenium precipitate. Carbon nutrient may be converted to biomass as it is consumed by the bacteria colony within the bioreactor bed 804. The bioreactor bed 804 may act as a biofilter to retain selenium precipitate or other contaminant precipitate as well as biomass. After treated feed water passes through the downflow bioreactor 802, it may be delivered out of the bioreactor 802 at an effluent port near the bottom of the bioreactor housing.

Other contaminants may also be converted by bacterial reduction in the downflow bioreactor 802 for removal, such as the reduction of nitrate and nitrite results in nitrogen (e.g., a gas) and the reduction of perchlorate results in a soluble chloride ion.

Water may be treated through the downflow bioreactor 802 when the bioreactor bed 804 is in a production mode. In a production mode, water may be pumped or pulled through the packed bed 804 so that contaminants in the water may come into contact with the biologically active biofilm. The environment within the downflow bioreactor 802 may be maintained in anoxic (e.g., anaerobic) condition to stimulate anoxic respiration and biological reduction. The flow rate of the water may be set so feed water remains in the bioreactor 802 with sufficient reaction time, or hydraulic retention time (HRT) to reduce the contaminants to a desired level. The hydraulic retention time may be between about 15 minutes to about 4 hours.

An effluent pump 810 may be used to draw or pull water out of the bottom of the bioreactor 802. Such a pump may provide negative pressure or vacuum, and may provide driving head to pull the water through the bioreactor bed 804 where dissolved contaminants may be reduced by biological activity and, in the case of precipitate end products, retained by the bed 804.

When driving head may be created below the bioreactor bed by drawing a vacuum, minimal liquid level may be used above the bioreactor bed 804 to push the feed water through the packed bed 804. As a result, downflow bioreactor tanks of this configuration may be considerably smaller compared to conventional fixed bed bioreactor tanks, which may use a large column of water over the bioreactor bed to provide driving head. Furthermore, in conventional fixed bed bioreactors, the available maximum head pressure may be limited by the height of the tank and the depth of the water column over the bioreactor bed. Maximum head pressure or head drive may not be limited by the height of the tank or the depth of the water column over the bioreactor bed 804, but by the pump 810.

When the fixed bed bioreactor 802 is operating, bacterial and other biological fermentation and respiration activity within the packed bed 804 may produce gas which can become trapped in the insoluble growth media and biofilm matrix, reducing the bed permeability over time. Similarly, biomass and contaminant precipitate build up in the packed bed 804 may also reduce the bed permeability over time. Loss of bed permeability may reduce bioreactor efficiency and may impede bioreactor operability. The fixed bed bioreactor 802 may operate within a broad range of pressure, such as between about negative (−) 5 psi and about 10 psi (0-23.1 ft H20), associated with bed permeability.

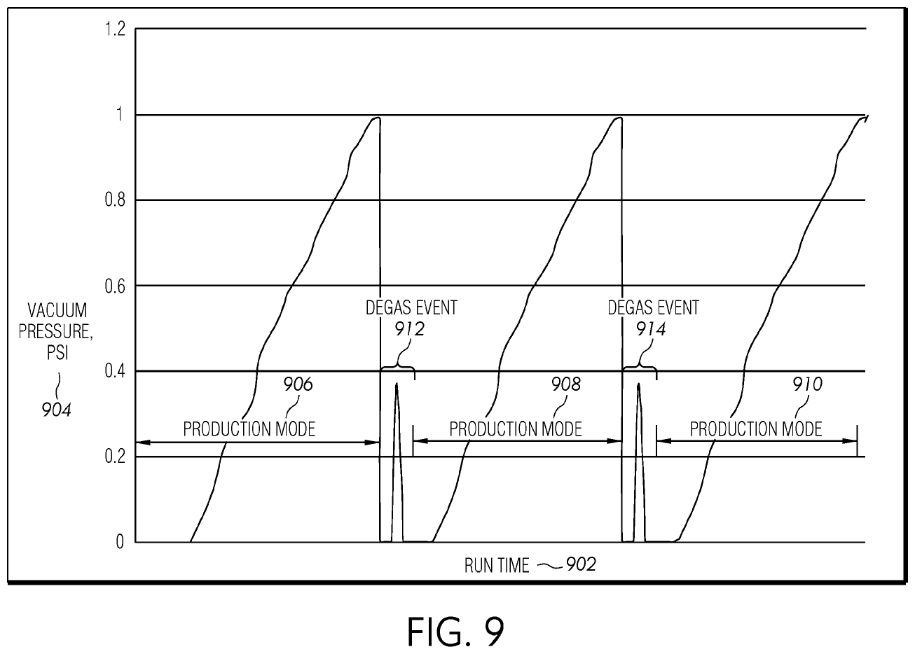

FIG. 9 is a diagram illustration of an embodiment 900 showing a graph of time 902 verses vacuum pressure 904. The vacuum pressure 904 may be measured by vacuum asserted by an effluent pump at the bottom of a downflow bioreactor, such as the bioreactor 802. The graph may show production modes 906, 908, and 910, as well as degassing events 912 and 914.

Effluent pressure data may be received from an effluent pressure gauge that may be mounted upstream from an effluent pump. This metric may allow for monitoring of biological activity and biological reaction kinetics inside a biologically active bed. Gas production may also be an indicator of biological activity. Thus, the rate of effluent vacuum pressure increase may indicate the biological reaction kinetics within a bioreactor bed. The kinetics related to gas production may be an indicator of the health of the living bacterial biofilm, which may then be optimized to further increase kinetics of the bioreactor system. Furthermore, effluent pressure data may provide the baseline effluent vacuum level that is achievable, which may be an indication of the bed porosity. Bed porosity may be used as an optimization point to control solids retention within the bed.

An automated degassing system may be provided to release gas from a bioreactor bed and restore or maintain a desired level of bed permeability.

Effluent pressure data may be obtained using a compound pressure gauge connected to an effluent pathway at a position downstream from a packed bed. As entrained gas accumulates in the packed bed and reduces bed permeability, a pressure change occurs as the effluent pump attempts to suck water through the bioreactor bed. When effluent pressure reaches a predetermined level or falls within a predetermined range, the effluent pressure gauge may signal a backwash pump motor to turn on to initiate pumping clean water from the filtration system into a backwash water conduit. The backwash pump may include a fixed speed motor or a variable frequency drive.

In a typical use case, an effluent pressure gauge may signal a backwash pump to turn on when pressure associated with suction of effluent from a downflow bioreactor is between about 2 psi and about negative (−) 2 psi. Operation of the backwash pump may be controlled by a programmable logic controller in response to data received by the programmable logic controller from the effluent pressure gauge.

Clean water from the filter system may be pumped by a backwash pump may be directed by a backwash water conduit into a downflow bioreactor through a port in the bottom of the downflow bioreactor below or adjacent to a bottom portion of the packed bed. The upward force of the clean water being pumped into the bottom of the downflow bioreactor may help dislodge and blow out gas entrained in the packed bed. The dislodged gas may rise up through the water and be released from the downflow bioreactor through an exit port near a top area of the bioreactor. The degassing system may pump water into the bioreactor up through the packed bed for only a short duration to facilitate dislodging of gas without dislodging substantial amounts of solids or waste from the system.

During the degas event, water may flow through the bioreactor system in a reverse direction at a hydraulic loading rate of about 5 to 15 gallons/minute per square foot of bioreactor surface area. The reverse flow of the water during the degas event may continue for between about 5 seconds and about 2 minutes, and sometime for about 60 seconds.

After a degassing event to remove entrained gas from the packed bed, if effluent pressure data indicates that the packed bed has failed to recover permeability after the gas flush, then failure to recover permeability may be caused by biomass, precipitate, or other solid waste accumulating in the packed bed. When effluent pressure data received shortly after gas flush indicates continued reduced permeability, the effluent pressure control gauge may signal the backwash pump to initiate a biomass backwash event. The biomass backwash event, also known as a biomass flush, may continue until accumulated solids are transferred to a solids handling system. The biomass backwash event may continue for a substantially longer period of time than a gas backwash event. The backwash event may be manually operated or may be automated using a programmable logic controller. Parameters of the backwash pump may be set in and controlled by the programmable logic controller, wherein the programmable logic controller may operate the backwash pump in response to data received by the programmable logic controller from the effluent pressure gauge. The reverse flow of water during the backwash event may continue for between about one and twenty minutes.

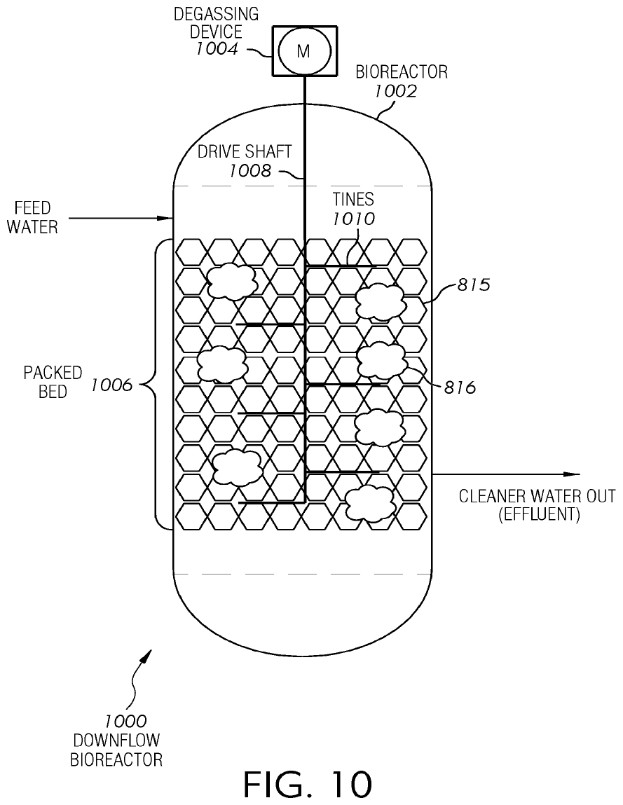

FIG. 10 is a diagram illustration of an embodiment 1000 showing a downflow bioreactor 1002, such as the bioreactor 140, which may have a degassing device 1004. The bioreactor 1002 may have a packed bed 1006, which may be agitated by the degassing device 1004 to assist release of gas, precipitate, and or carbonaceous matter resulting from biological activity. The degassing device 1004 may comprise a drive shaft 1008 extending into the bioreactor bed 1006, wherein the drive shaft 1008 includes one or more tines 1010 extending laterally through the bed and may be rotated at various depths. The degassing device 1004 may include a motor for actuating rotation of the drive shaft 1008 for agitating the bed during a degas event to assist with dislodging the entrained gas, precipitate, and or carbonaceous matter from the bioreactor bed 1006. During a degassing sequence, water may be pumped up through the bottom of the bioreactor bed 1006 at a flow rate of between about 1 to about 15 gpm/ft2 during rotation of the degassing device 1004 to further expel entrained gases from the bioreactor bed 1006.

The automated degassing feature and automated backwash feature may reduce the driving head needed to push water through the bioreactor bed by restoring and maintaining optimal bed permeability. Thus, the automated degassing feature and automated backwash feature may allow for reduced bioreactor tank height and volume. This is an important cost consideration, as the bioreactor height impacts tank volume and height, building height, shipping costs, tank wall thickness, and several other cost components.

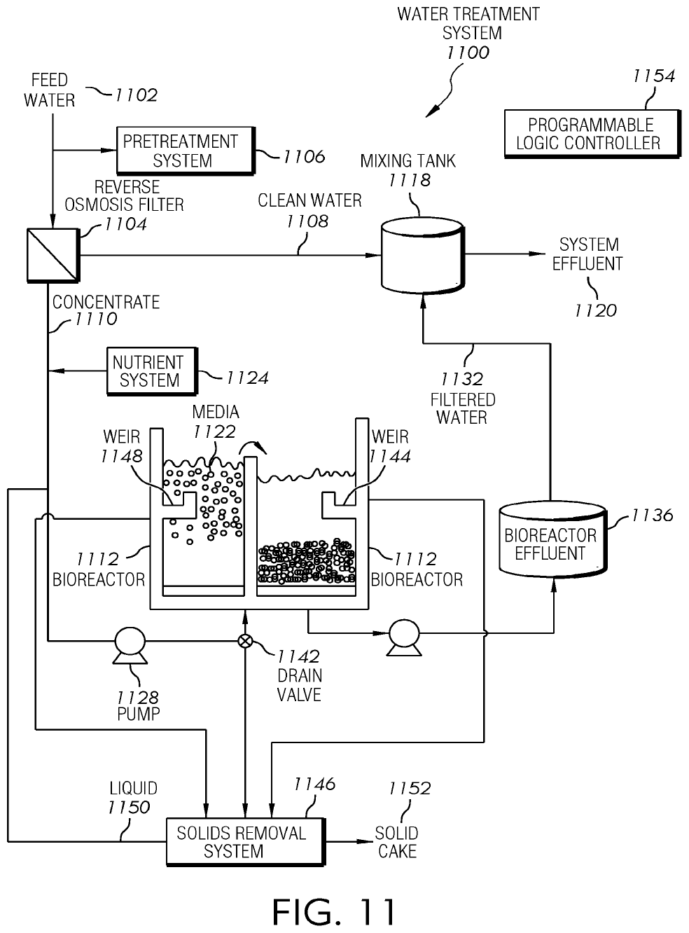

FIG. 11 is a diagram illustration of an embodiment 1100 showing a water treatment system. The water treatment system 1100 treats a concentrated water stream that is an effluent of a reverse osmosis system.

A supply of feed water 1102 is fed into a reverse osmosis filtration system 1104, which produces a clean water stream 1108 and a concentrated contaminated water stream 1110. The clean water stream 1108 is fed to a mixing tank, while the concentrated contaminated water stream 1110 is fed through a multi-stage water treatment process that removes contaminants and produces filtered water 1132. The filtered water 1132 is mixed with the clean water stream 1108 to produce system effluent 1120.

A typical system may receive feed water 1102 with 40-800 PPB of selenium, for example, and may remove up to 98% of the contaminants, yielding a system effluent 1120 of less than 1.25 PPB to less than 64 PPB, depending on processing conditions.

The reverse osmosis filtration system 1104 may produce a concentrated contaminant water stream that may have between 50 and 600% higher concentration of contaminants, including selenium, mercury, arsenic, or other toxic materials. The higher concentration of contaminants may be more easily processed using biological and subsequent mechanical filtration mechanisms than water with lower concentrations.

The reverse osmosis filtration system 1104 may produce permeate clean water 1108 and a concentrate 1110 stream. The concentrate may have 140 to 3200 PPB of contaminants, and after processing, the filtered water 1132 may have less than 3 PPB to less than 64 PPB. This filtered water 1132 may be diluted down with the clean water 1108, yielding finished water at less than 1.25 PPB to less than 64 PPB contaminants.

The reverse osmosis filtration system 1104 may use a pretreatment system 1106. Pretreatment may be used to optimize filtration performance to minimize reverse osmosis scaling, fouling, and degradation of the filtration membranes. Scaling may occur when the concentration of various scale forming species exceeds saturation, which may produce additional solids in the membranes. Scalants may include such chemical species as calcium carbonate, calcium sulfate, barium sulfate, strontium sulfate, and reactive silica. Since these species have very low solubilities, they may be difficult to remove from RO membranes. Scaling decreases the effectiveness of the membranes in reducing the solids and causes more frequent cleanings. A scale on a membrane provides nucleation sites that increase the rate of formation of additional scale.

In order to minimize scaling in the reverse osmosis filtration system 1104, a pretreatment system 1106 may use various anti-scalant methodologies to minimize scaling. While such methodologies may ensure that the reverse osmosis filtration system 1104 may operate well, the scalants and anti-scalants are then transferred to the bioreactors in very high concentrations in the contaminant concentrate water stream 1110.

One particularly difficult problem that may occur in such a system is that the scalants may be present in supersaturated quantities, which normally may be processed using an upflow and downflow bioreactor. However, when the bioreactors are shut down, the scalants may come out of solution and cause very real damage to the bioreactors. In many cases, a power outage or other shut down of the bioreactors may cause the medium in the bioreactors to become solidified with scalants and the anti-scalants. If such a situation were to occur on industrial sized bioreactors, the cleaning mechanism may require jackhammers and difficult manual cleaning of the bioreactors.

A typical pretreatment system 1106 may use chemical techniques to change the characteristics of feed water 1102 to so that crystal formation is not favored. An example of a chemical technique to prevent fouling is lime softening, which involves chemical processes that reduce the hardness of the wastewater, essentially preventing material from precipitating out. Lime, soda, ash, and NaOH may be used to convert soluble calcium and magnesium to insoluble calcium carbonate and magnesium hydroxide. Magnesium hydroxide tends to absorb silica, another scalant. These solids may then be collected as sludge through a solids removal system 1146 of the water treatment system.

Another softening procedure may involve zeolite in an ion exchange process. A strong acid cation resin in the sodium is used to remove scale-forming cations, such as calcium, magnesium, barium, and iron. These cations may be exchanged with the sodium to yield “soft water,” that is, water of low hardness.

Another pretreatment technique to prevent scaling may be acidification, which specifically reduces the crystallization of calcium carbonate. Sulfuric acid may be used in this process, but can often increase the formation of sulfate scales. Therefore, where sulfuric acid cannot be used, hydrochloric acid may be substituted. Often used with acidification, or by itself, are antiscalants. Antiscalants may be chemicals that may be added to wastewater to minimize scale carbonate or sulfate based scale. They consist of acrylates and phosphonates which inhibit the precipitation of carbonate or sulfanates.

All of the anti-scalant techniques for the reverse osmosis filtration system 1104 can cause highly concentrated levels of both the scalant and anti-sealant to be present in the contaminated concentrate water stream 1110. The high concentration of these species can cause the bioreactors to solidify when shut down.

To address the problems with shutting down the bioreactors, the water treatment system 1100 may have a deconcentrator operation that may flush the bioreactors with treated water to reduce the concentration levels of scalants below a level where they may cause harm to the bioreactor. The deconcentrator operation may be performed in an emergency, such as when power may be lost, or during normal operation when a bioreactor may be taken offline for servicing or in response to demand.

The contaminant concentrate water stream 1110 may have high levels of selenium and other toxic metals, often in the range of 100 PPB to 800 PPB ore more.

A nutrient system 1124 may inject nutrients that may be consumed by biological agents in the bioreactors. The nutrients may include various sugars and other carbon based nutrients that maintain biological activity.

A pump 1128 may supply incoming water into an upflow bioreactor 1112, where a majority of biological activity may occur. The upflow bioreactor 1112 may maintain an upward water flow of about 2 to 5 gpm/ft2 in a plug flow regime.

The upward flow of water may cascade over a weir or barrier directly into a downflow bioreactor 1114.

The upward flow of water in the upflow bioreactor 1112 may be maintained such that the weight of the media 1122 with its biofilm may keep the media 1122 inside the bioreactor 1112 and not be carried over the barrier. Higher levels of flow may cause the media to be carried by the water flow into the second bioreactor 1114. Lower levels of flow may cause the media to settle at the bottom and the bioreactor bed may not be fully expanded.

The upward flow of water in the upflow bioreactor 1112 may help express any gasses that may be generated during the biological activity. In many cases, the bioreactor 1112 may produce hydrogen sulfide (H2S) or other gasses. As the water reaches the top of the bioreactor 1112, the gasses may be expressed into the atmosphere. In some cases, the gasses may be collected.

The upflow bioreactor 1112 may have colonies of bacteria, fungi, yeast, or other biological agents that may consume the nutrients, but also may convert dissolved materials, such as the various forms of selenium including selenite and selenate, into elemental selenium, which may be a solid form. The solids may then be captured in the biomass of the upflow reactor 1112, the packed bed of the downflow reactor 1114, or the filter 1116. The upflow bioreactor 1112 may operate in at least a partial anaerobic condition, such that the biological agents may consume and process dissolved materials.

The downflow bioreactor 1114 may receive treated water from the upflow bioreactor 1112. This water may contain excess carbon-based nutrients that may not have been consumed by the biological agents in the upflow bioreactor 1112, as well as particles of selenium or other byproducts of the biological digestion. The biological activity in the packed bed downflow bioreactor 1114 may consume the remaining nutrients as well as mechanically trap the solid particles produced by the biological activity.

The particles trapped in the media 1126 may be mechanically lodged in biofilm that may surround the media particles. In other cases, the particles may be mechanically trapped by the tortuosity of the media bed.

A pump 1130 may draw water out of the bioreactor 1114 and pump produce filtered water 1132 to a mixing tank 1118, which may be mixed with the clean water 1108 to produce the system effluent 1120.

The bioreactors 1112 and 1114 may become less effective over time, as biomass may increase and solid and gaseous contaminants may become entrapped in the media. Each of the bioreactors may be flushed to restore the media beds.

Typically, the upflow bioreactor 1112 may be flushed when the biomass within the bioreactor may grow such that the media bed expands past an operational limit. A typical automated system may have a series of sensors in the bioreactor that may measure the height of the media bed. In some cases, such a system may use a sonar system to measure the bed depth. When the bed depth may exceed a predefined limit, an automated controller, such as a programmable logic controller 1154 may cause the system to perform a backflush operation.

The upflow bioreactor 1112 may be flushed by opening the weir 1148 and pumping larger amounts of concentrated feed water. The weir 1148 may direct the overflow to the solids removal system 1146.

During a backwash cycle, clean water may be introduced at flow rates from 120 to 200% of feed water flow, or 2.4 to 10 gpm/ft2. In some cases, backwash water flow may be 150%, 250%, 300%, or more of the normal feed water flow rate. The flow of clean water may be significantly faster than normal operation, which may cause turbulent flow. Such flow may cause the media to mechanically abrade and dislodge portions of biofilm. The biofilm may be carried into the weir 1148 and processed by a solids removal system 1146.

In some cases, air scouring may be performed, where an air manifold in the bottom of the bioreactor 1112 may be fed high pressure air. The high pressure air may form bubbles that may agitate, aerate, and otherwise abrade the media and the biofilm. In many cases, the bioreactor 1112 may be normally operated under anaerobic conditions, so that aeration may disrupt the normal anaerobic conditions of the biological agents. As such, air scouring may be performed for a brief period at the beginning of a backwash cycle, such as 30 to 60 seconds. The backwash cycle may then continue flushing with clean water for several more minutes to begin to reestablish an anaerobic condition.

The bioreactor 1114 may undergo a backwash cycle from time to time. The packed media bed may increase in biomass as well as entrapped particulates, gasses, and other materials. As such, the packed media bed may increase in flow resistance, which may be measured by a vacuum sensor located upstream of the pump 1130 or by other mechanisms, such as the energy consumed by the pump 1130 to achieve a specific volumetric flow rate.

A programmable logic controller 1154 may sense that the flow through the packed media bed of the bioreactor 1114 may increase past a predefined limit, then may cause a backwash operation to be performed.

In many systems, a backwash indication of one of the bioreactors 1112 and 1114 may cause the other bioreactor to also undergo a backwash operation.

The backwash operation of the bioreactor 1114 may involve reversing the pump 1130 and opening a drain on the weir 1144. By reversing the pump 1130, bioreactor effluent 1136 may be reintroduced into the bioreactor 1114. Excess water over the level of the weir 1144 may drain to the solids removal system 1146. The backflow may cause the water to agitate and clean the media 1126, and the resulting water may be captured and sent to the solids removal system 1146.

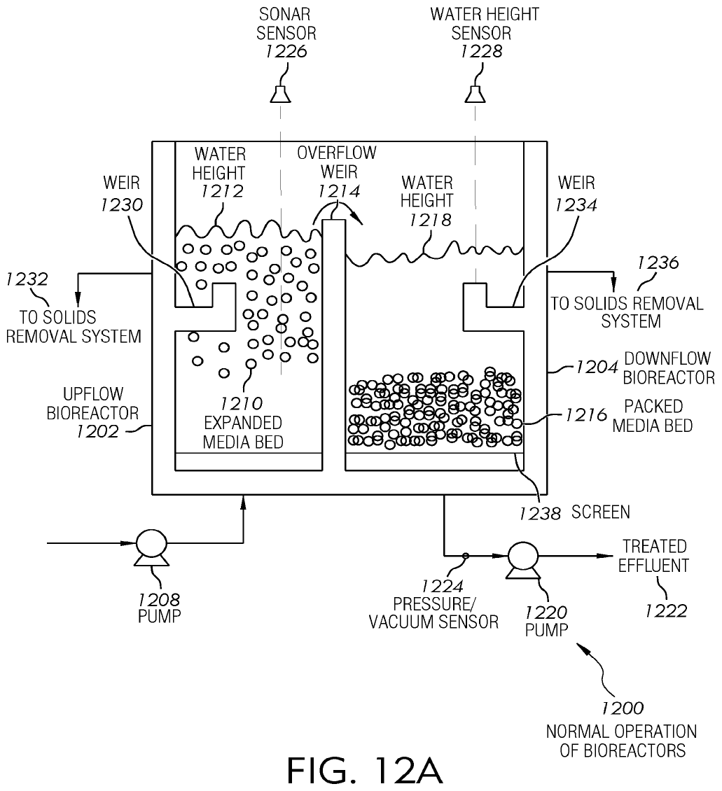

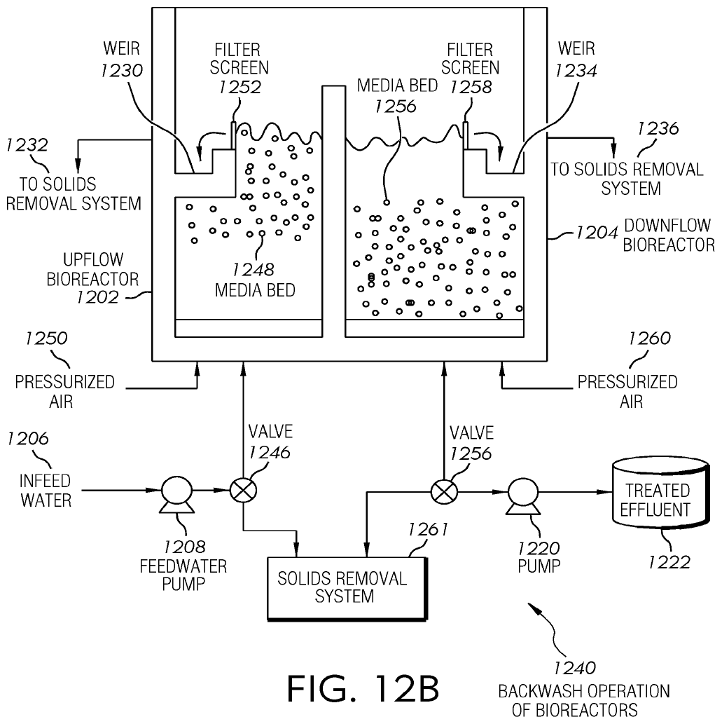

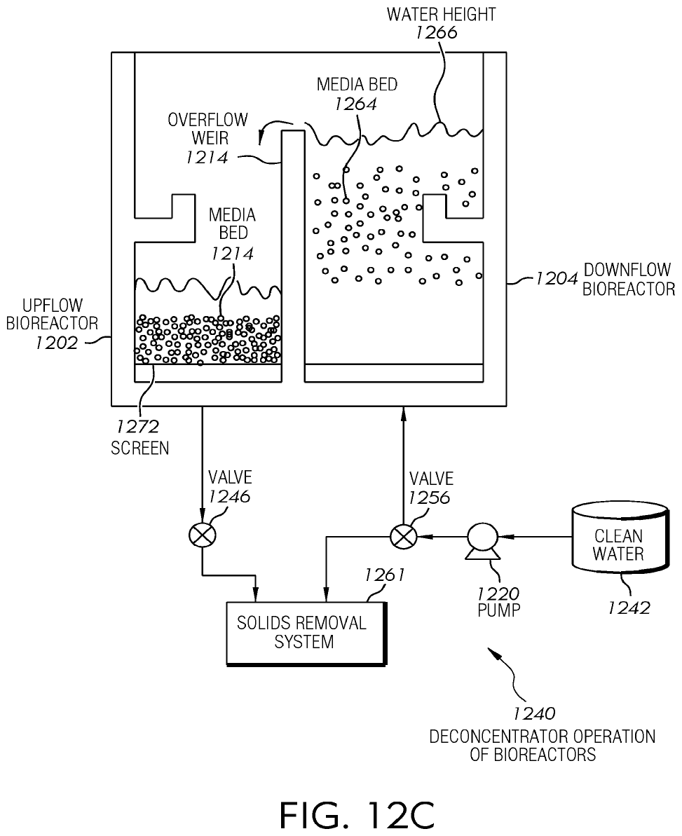

FIG. 12 is a diagram illustration of an embodiment 1200 showing a set of bioreactors during normal operation. An upflow bioreactor 1202 is shown upstream from a downflow bioreactor 1204. Embodiment 1200 may represent one example of the combination of upflow and downflow bioreactors illustrated elsewhere in this specification.

Infeed water 1206 may be introduced to the bottom of the upflow bioreactor 1202 through an infeed pump 1208. The infeed water 1206 may be untreated, unfiltered water, or may be concentrated water that may be concentrated by a reverse osmosis system or other concentration system. The infeed pump 1208 may be controllable to adjust the water flow into the upflow bioreactor 1202.

An expanded media bed 1210 may have media on which biological agents may attach themselves. The biological agents may be bacteria, fungi, yeasts, or other agents or combination of agents. The biological agents may consume nutrients in the water steam, as well as harmful species, such as selenium, mercury, arsenic, or other materials. The agents may process soluble forms of harmful materials into precipitate, such as solid elemental forms of selenium, for example. The precipitate may be captured in a packed media bed 1216 or other filtration mechanisms. In some cases, the precipitate may be entrained in the biomass of the expanded media bed 1210.

The expanded media bed 1210 may be formed by incoming water flow that may cross over an overflow weir 1214 to exit the upflow bioreactor 1202. The water flow may be selected such that the media may remain in the upflow bioreactor 1202 during normal operation, yet may expand the media bed to have increased contact time with the incoming water. In many cases, the flow rates may be between 2 gpm/ft2 and 5 gpm/ft2. In some cases, the flow rates may be as high as 6, 7, 8, or 10 gpm/ft2, or as low as 1.5, 1.25, 1.0, or 0.75 gpm/ft2.

The flow rates may define a retention time of the water in each of the bioreactors 1202 and 1204, as well as a total retention time for the pair of bioreactors. In a typical system, the hydraulic retention time for both bioreactors may be in the range of 15 to 45 minutes. Some systems may be in the range of 20 to 40 minutes, while other systems may be in the range of 25 to 35 minutes. In general, the longer the retention time, the more biomass may be created and the more cleaning may occur. Empty bed contact time may reflect the time that water is in contact with the reactive beds. In a typical design, the empty bed retention times may be several minutes more than the hydraulic retention times.

The two bioreactors 1202 and 1204 may have different retention times. In some systems, the downflow bioreactor may have bed contact times that are substantially the same as the upflow bioreactor, while in other systems, the downflow bioreactor may have 1.25, 1.5, 1.75, 2.0, 2.5, 3.0, 4.0 times the bed contact time as the upflow bioreactor. Still other systems may have more than 4 times the bed contact time in the downflow bioreactor as the upflow bioreactor.

A sonar sensor 1226 may be able to measure the height of the expanded media bed 1210 during operation. Other types of sensors may also be used to detect the media bed height, including optical switches, turbidity probes, and other sensors. In some cases, the top of the media bed may be maintained some distance below the water height 1212, while in other cases, the media bed may be permitted to reach to the water height 1212.

The sonar sensor 1226 may be used to adjust the incoming flow rate of the infeed water 1206 by adjusting the speed of the pump 1208. The sonar sensor 1226 may be used to speed up or slow down the pump 1208 such that the top of the media bed 1210 maintains a predetermined level. In some cases, the sonar sensor 1226 may be used to measure the bottom of the media bed 1210 and a programmable logic controller may adjust the speed of the pump 1208 to maintain a predefined bottom level of the media bed 1210.

Partially treated water from the upflow bioreactor 1202 may cascade into the downflow bioreactor 1204 across the overflow weir 1214. In many cases, the overflow weir 1214 may be a wall that may separate the two bioreactors. The downflow bioreactor 1204 may have a screen 1238 or other device that may prevent media from being drawn into the pump 1220 and into the treated effluent 1222.

An outflow pump 1220 may draw water out of the downflow bioreactor 1204 to generate treated effluent 1222. The outflow pump 1220 may pull water, creating a negative pressure across the packed media bed 1216. A pressure or vacuum sensor 1224 on the line between the bioreactor 1204 and the pump 1220 may measure the amount of negative pressure that the pump 1220 may be creating.

The pump 1220 may be controlled through a programmable logic controller or other device to maintain the water height 1218 at a predefined level. A water height sensor 1228 may be an input to such a controller, and the controller may increase the speed of the pump 1220 when the water height 1218 may rise, or may decrease the speed of the pump 1220 when the water height 1218 may drop.

The negative pressure measured on the pressure sensor 1224 may be an indicator of a backwash operation. As the packed media bed 1216 may entrain gasses, precipitates, and as biomass may increase, the resistance to downward flow may increase. At a predefined level, a programmable logic controller may identify that a backflush operation may be appropriate.

The bioreactor 1204 may have a flushing weir 1234, which may drain to a solids removal system 1236. In many cases, such a drain may be gravity fed, although some cases may have a pump for assisting the flow.

The media bed 1216 may be supported by a screen 1238, or other media retention device, which could include an underdrain.

The bioreactor 1204 may operate at a flow rate of 2.5 to 3.5 gpm/ft2. In other cases, the downflow bioreactor 1204 may operate at a flow rate between 2 and 4 gpm/ft2, 1 and 5 gpm/ft2, or over 5 gpm/ft2. In many case, the bioreactor 1204 may operate at a lower flow rate than the bioreactor 1202. Such a design may permit higher contact time in the second bioreactor than the first bioreactor in some cases.

FIG. 12B is a diagram illustration of an embodiment 1240 showing a backwash operation for both upflow bioreactor 1202 and downflow bioreactor 1204.

During a backflush operation for upflow bioreactor 1202, the feedwater pump 1208 may pump untreated infeed water 1206 into the bioreactor 1202 from the bottom. A valve 1246 may be configured to direct water from the pump 1208 into the bioreactor 1202, and may also be configured to drain the bioreactor 1202 into the solids removal system 1261. During a backflush operation, a pump or valve attached to the weir 1230 may draw water into the solids removal system 1232.

A backflush operation of the upflow bioreactor 1202 may draw down the water level to the level of the weir 1230, then may pump feed water into the bottom of the bioreactor 1202. In some cases, a pressurized air injector may be used for air scouring of the bioreactor 1202. A filter screen 1252 may prevent media and other large objects from being lost into the weir 1230.

The clean water may be pumped in at 120% to 200% of the normal operating flow rates. The speeds may be selected such that the media bed 1248 may be agitated, abraded, or otherwise cleaned. In many cases, the speeds may be selected to encourage turbulent flow, rather than plug flow as in normal operation. Any precipitate, excess biomass, or other solids may be collected in the weir 1230 and processed by the solids removal system 1261.

The downflow bioreactor 1204 may be backwashed by reversing the pump 1220 which may pump treated effluent 1222 into the bottom of the bioreactor 1204. A valve 1256 may be configured to direct water from the pump 1254 into the bioreactor 1204, or may be configured to drain the bioreactor 1204 into the solids removal system 1261.

During a backwash operation, the weir 1234 may be opened to drain excess water into the solids removal system 1236. In many cases, a filter screen 1258 may prevent media and other objects from being lost in the weir 1234.

The backwash operation may be performed at flow rates of 12 to 15 gpm/ft2 which may be selected to clean the media bed 1256. The cleaning operation may remove entrapped gasses, and dislodge precipitates as well as excess biomass from the media bed 1256. The solids may be captured by the weir 1234 and processed by the solids removal system 1261. Some systems may include an injector for compressed air 1260 which may provide an air scour of the bioreactor 1204.

FIG. 12C is a diagram illustration of an embodiment 1262 showing an upflow bioreactor 1202 and downflow bioreactor 1204 undergoing a deconcentrator operation. The deconcentrator operation may be performed when shutting down a set of bioreactors, such as when power may be interrupted or during normal servicing.

A deconcentrator operation may flush the bioreactors with clean water to reduce the concentration of scalants in the bioreactors. In many cases, especially when treated water concentrated by reverse osmosis where anti-scalants are injected beforehand, superconcentrated amounts of scalants may be present in the water. If the water flow may be inadvertently stopped, the scalants may come out of solution and harden inside the bioreactors. The deconcentrator operation may reduce the concentration of scalants to ensure that the bioreactors may be restarted easily without fouling.

A deconcentrator operation may cause clean water 1242 to be introduced into the bottom of the downflow bioreactor 1204. The clean water 1242 may be clean water or permeate from an upstream reverse osmosis system, or may be bioreactor effluent that may have been diluted with clean water. In some cases, a deconcentrator operation may begin by backwashing with bioreactor effluent, which may drain diluted bioreactor effluent into the piping. From FIG. 11, an example of treated water from the bioreactors may be the bioreactor effluent 1136, while an example of diluted water may be the water in mixing tank 1118.

During deconcentration, the media bed 1264 may be expanded to deconcentrate any scalants in the media bed 1264, and the water may overflow the overflow weir 1214 back into the normally upflow bioreactor 1202.

The valve 1246 at the bottom of the upflow bioreactor 1202 may be configured to drain into the solids removal system 1261, and the excess water from the bioreactor 1204 may flush or deconcentrate the water in the bioreactor 1202. The water height 1270 may drop as the valve 1246 may be opened.

In some systems, the valve 1246 may be configured to allow excess water to drain back into the feed water source. Such a configuration may be possible when the feed water source may be physically lower than the bioreactor 1202.

The deconcentrator operation may be configured as a fail safe configuration. In such a configuration, a tank of clean water 1242 may be located physically above the water height 1266, which may cause the inflow of water to be performed by gravity. The pump 1220 may be capable of allowing the gravity-fed water to pass by the pump, and the valve 1256 may be configured in a normally-open fashion to automatically switch to permit flow for the deconcentrator operation. Similarly, the valve 1246 may be configured in a normally open fashion to drain the bioreactor 1202. Such a configuration may cause the deconcentrator operation to be automatically performed when power may be lost.

When a deconcentrator operation is performed under power, the flow rates of water entering the downstream bioreactor 1204 may be similar to the flow rates for normal back flushing operation.

In some cases, a fail safe deconcentrator operation may be performed using battery backup or an alternative power source. In such a case, the deconcentrator operation may be initiated by a programmable logic controller when a power disruption may be detected, and valve operations, pump operations, or other operations may be powered using battery backup or an alternative power source.

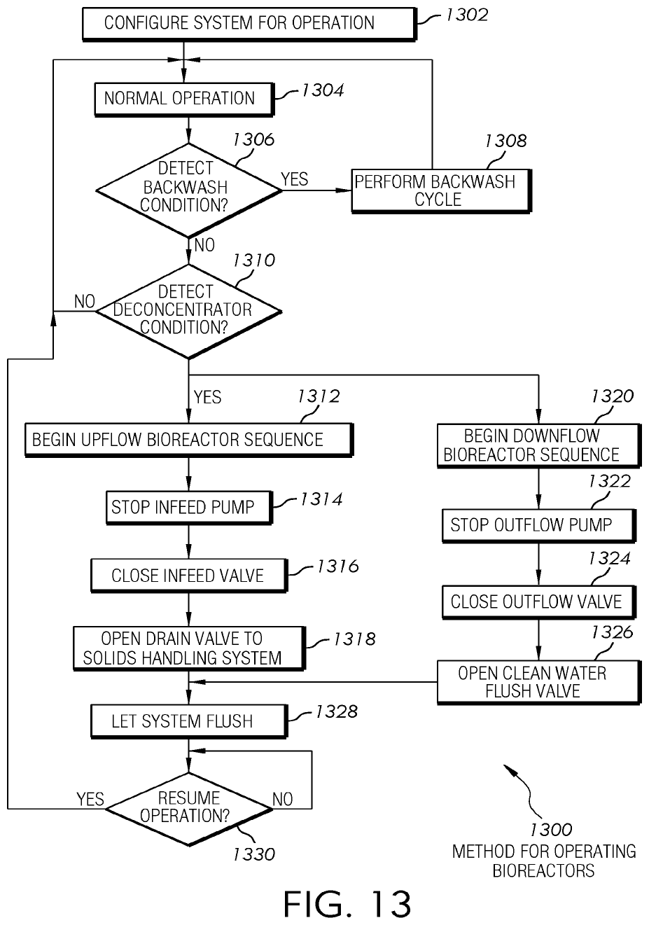

FIG. 13 is a flowchart diagram of an embodiment 1300 showing a method for operating a dual bioreactor system, such as the system of embodiment 1200 and others in this specification.

The system may be configured for operation in block 1302 and normal operation may begin in block 1304. During normal operation, a programmable logic controller or other controller may check various sensors to determine when a backwash condition may be met in block 1306. If the conditions are met for a backwash in block 1306, a backwash operation may be performed in block 1308.

If the backwash conditions are not met in block 1306, a check may be made in block 1310 for a deconcentrator condition. A deconcentrator condition may be a power failure, or in some cases, may be a condition where a train of bioreactors may be taken offline for some purpose, including regular maintenance.

The deconcentrator operation involve both bioreactors, both of which may be have operations happening in parallel.

The upflow bioreactor sequence may begin in block 1312, where the infeed pump may be stopped in block 1314 and any infeed valves may be closed in block 1316. A drain from the bioreactor may be opened in block 1318 to drain the bioreactor contents to a solids handling system. In some cases, the drain may allow water from the bioreactor to drain back into the water source.

The downflow bioreactor sequence may begin in block 1320, where the outflow pump may be stopped in block 1322 as well as any outflow valve 1324. A clean water flush valve may be opened in block 1326 to cause clean water to feed into the downflow bioreactor.

When configured in this state, the system may flush in block 1328, where the incoming clean water may deconcentrate the downflow bioreactor, and the overflow from the downflow bioreactor may spill into the upflow bioreactor to deconcentrate the upflow bioreactor. The result may be deconcentrated conditions in both bioreactors. When the system is ready for resuming operations in block 1330, the process may resume at 1304.

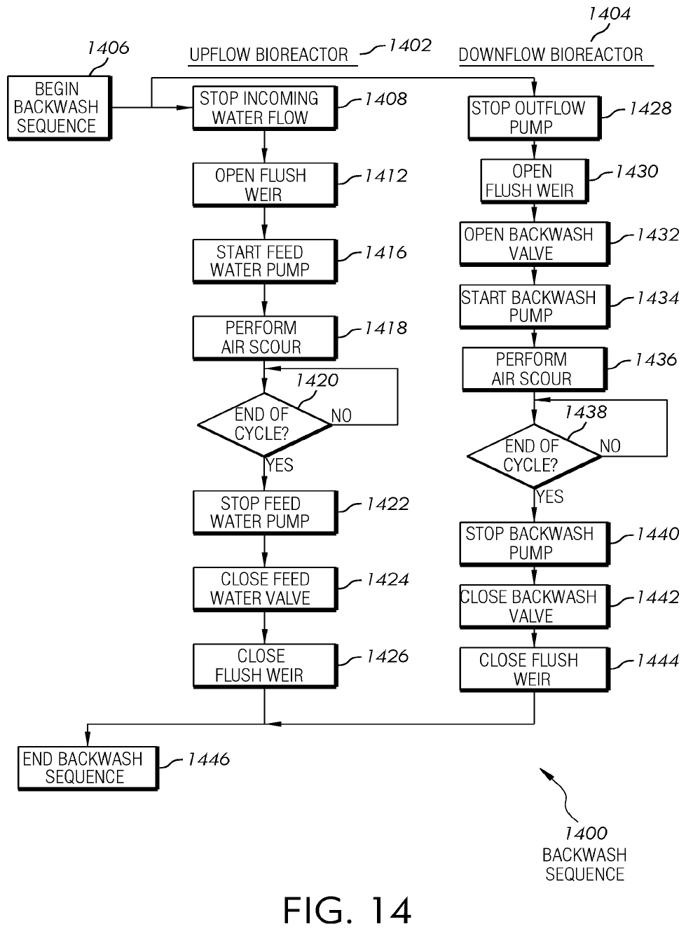

FIG. 14 is a flowchart illustration of an embodiment 1400 showing a backwash sequence, which may be similar to the backwash sequence of block 1308 in embodiment 1300.

A backwash sequence may be similar to a flush sequence. In a backwash sequence, the bioreactors are agitated and, in some cases, scoured to dislodge and remove solids. A flush sequence may be similar, but may be performed to release gases that may be entrapped in a bioreactor's media bed.

The operations of an upflow bioreactor 1402 may be shown in the center column, while the operations of a downflow bioreactor 1404 may be shown in the right hand column.

The backwash sequence may begin in block 1406. The operations of the upflow bioreactor 1402 and downflow bioreactor 1404 may be performed in parallel. In a typical use case, the backflush operations of the two bioreactors may be performed independently.

The upflow bioreactor 1402 may stop incoming water flow in block 1408. A flush weir may be opened in block 1412.

The feed water pump may be started in block 1416 and water may be introduced to clean the media bed. In some cases, the feed water pump may be set to a higher than normal flow rate. This may cause the media bed to discharge gases, as well as agitate and remove excess biomass and solids from the media bed.

In some cases, an air scour system may be activated in block 1418 to help mechanically scrub the bioreactor and the media bed. A typical air scour may be performed for a relatively short period of time compared to the backwash water flow because an upflow bioreactor may be normally operated in an anaerobic condition, which may be somewhat upset by the air scour operation.

The backflush may operate until the end of cycle in block 1420, after which the feed water pump may be stopped in block 1422 and the feed water valve closed in block 1424. The flush weir may be closed in block 1426, which may end the backwash cycle for the upflow bioreactor 1402.

The downflow bioreactor 1404 may begin a backwash cycle by stopping the outflow pump in block 1428, opening a flush weir in block 1430, and opening a backwash valve in block 1432.

A backwash pump may be started in block 1434. In some cases, an air scour operation may be performed in block 1436. The backflush operation may continue in block 1438 until an end of cycle timeout or other indicator occurs. The backwash pump may be turned off in block 1440 and a backwash valve may be closed in block 1442. The flush weir may be closed in block 1444, and the backwash of the downflow bioreactor 1404 may be complete. When both backwash operations have completed, the backwash sequence may end in block 1446.

### Example 1

An industrial water treatment system was constructed for treating mine water runoff. The system capacity was 500 gallons per minute.

This system had two trains each of ultrafiltration and reverse osmosis filtering, which fed three bioreactor trains. The incoming raw water had up to 800 PPB of dissolved selenium. The concentrate sent to the bioreactors contained up to 3200 PPB of dissolved selenium, and the bioreactor effluent produced on average less than 64 PPB. The finished water contained less than 16 PPB of dissolved selenium.

### Example 2

An industrial water treatment system was constructed for treating mine water runoff. The system capacity was 2000 gallons per minute.

This system had six trains each of ultrafiltration and reverse osmosis filtering, which fed six bioreactor trains. The incoming raw water had up to 300 PPB of dissolved selenium. The concentrate sent to the bioreactors contained up to 1200 PPB of dissolved selenium, and the bioreactor effluent produced an average of less than 20 PPB. The finished water contained less than 5 PPB of dissolved selenium.

All references to gallons in this specification refer to US gallons.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable form.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

1. A method of treating contaminated water using a biologically active water treatment system comprising:
providing an upflow bioreactor having a bioreactor bed comprised of a first insoluble particulate growth media suitable for growing a first bacteria colony thereon, wherein the upflow bioreactor is capable of receiving feed water from a water source and wherein the upflow bioreactor is capable of releasing effluent water through an upflow bioreactor effluent port;
providing a downflow bioreactor having a bioreactor bed comprised of a second insoluble particulate growth media suitable for growing a second bacteria colony thereon, wherein the downflow bioreactor is configured to receive the effluent water from the upflow bioreactor and wherein the downflow bioreactor is capable of releasing treated water through a downflow bioreactor effluent port;
selecting the contaminated water containing one or more contaminants that are capable of being reduced by biological reduction comprising selenate, selenite, perchlorate, methyl mercury, arsenic, nitrate, or nitrite;
processing said contaminated water through a reverse osmosis system to produce concentrated contaminated water;
feeding the concentrated contaminated water into the upflow bioreactor so that the concentrated contaminated water travels upwards through the upflow bioreactor under anaerobic conditions for a contact time greater than 25 minutes and less than 2 hours; and
directing an effluent from the upflow bioreactor into the downflow bioreactor.

2. The method of claim 9, further comprising actuating an effluent pump that is connected to the downflow bioreactor effluent port to pump the treated water from the downflow bioreactor.

3. The method of claim 10 further comprising:
activating an automated backwash pump when a pressure of suction of the effluent from the downflow bioreactor is between about 2 psi gauge pressure and about negative 2 psi gauge pressure.

4. The method of claim 10, further comprising:
channeling the treated water from the downflow reactor effluent port into a membrane filtration system.

5. The method of claim 12, wherein the membrane filtration system is an ultrafiltration membrane filter having a pore size of between about 0.1 to about 0.001 microns.

6. The method of claim 12, wherein the membrane filtration system is a microfiltration membrane filter having a pore size of between about 0.1 to about 3 microns.

7. The method of claim 9, the first insoluble particulate growth media being the same as the second insoluble particulate growth media.

8. The method of claim 9, the first bacteria colony being the same as the second bacteria colony.
